(19) United States
(12) Patent Application Publication
(10) Pub. No.: US 2025/0390896 A1
(43) Pub. Date: Dec. 25, 2025

(54) SYSTEM AND METHOD FOR ANALYZING PUBLIC RESPONSE

(71) Applicants: Sachin Ramesh Raval, Hoboken, NJ (US); Sujit Mahbubani Ramchand, Rego Park, NY (US)

(72) Inventors: Sachin Ramesh Raval, Hoboken, NJ (US); Sujit Mahbubani Ramchand, Rego Park, NY (US)

(21) Appl. No.: 19/246,575

(22) Filed: Jun. 23, 2025

Related U.S. Application Data
(60) Provisional application No. 63/663,475, filed on Jun. 24, 2024.

(51) Int. Cl. G06Q 30/0201; G06Q 50/00

(52) U.S. Cl. CPC G06Q 30/0201; G06Q 50/01

(57) ABSTRACT

A computer-implemented system for evaluating public response of a subject matter, including individuals, entities, events, policies, products, places, ideas, or other evaluable subject. The system collects and verifies data from third party sources, such as social media, news sites, etc. The system identifies deeds of the evaluable subject and corresponding public responses using natural language processing, rules-based logic, sentiment analysis, data modeling, etc. The public responses are weighted, e.g., based on credibility, sentiment time-decay functions, or other factors, to generate a public response score.

### CROSS REFERENCE TO RELATED APPLICATIONS

This application is a U.S. non-provisional patent application claiming priority under 35 U.S.C. § 119(e) to U.S. provisional patent application No. 63/663,475, filed Jun. 24, 2024, entitled, “SYSTEMS AND METHODS FOR PROVIDING AND TRACKING GRATITUDE NOTICES,” which is hereby expressly incorporated by reference as if fully set forth herein.

### COPYRIGHT NOTICE

A portion of the disclosure of this patent document contains material which is or may be subject to copyright protection. The copyright owner has no objection to the facsimile reproduction by anyone of the patent document or the patent disclosure, as it appears in the Patent and Trademark Office patent file or records but otherwise reserves all copyrights whatsoever.

### FIELD

Embodiments of the present application generally relate to a computer network and application that collects and analyses public and private data related to a subject or deed and evaluates a public response to the subject or deed.

### BACKGROUND OF THE INVENTION

We live in a world where people like to share and publicize many aspects of their personal and professional lives and seek affirmation online. People share on social media information about the food that they are eating, the restaurants where they dine, the company that they keep, their vacations, the clothes they wear, and the parties they attend.

Daily, millions of people around the world perform acts of help and kindness. For example, a college student mows the lawn of a neighbor, a professional provides free professional services for a family member or friend, or a churchgoer may partake in a fundraising campaign at their local church. Many individuals make donations to various charities and alumni associations, help neighbors, and volunteer. Gratitude for such acts of kindness is often expressed privately, if at all, and done so over a phone call or by text or by email, and the matter ends there privately. There is currently no easy way to share appreciation for such acts of kindness on social media. There are currently no social media websites that provide a public documentation of an act of kindness and no databases or compilations of the acts of kindness of an individual or company.

Thus, there is a need for a public computerized system and method for easily providing public gratitude for acts of kindness and for tracking and compiling acts of kindness in a searchable database.

In addition, in the digital age, public perceptions of individuals, organizations, and institutions are increasingly shaped by online interactions and content. While systems exist to analyse sentiment or engagement for marketing, political, or financial insights, no known system systematically quantifies a person's or an entity's social impact through the lens of public gratitude, charitable contributions, positive social impact and/or acknowledgment. Millions of individuals and organizations contribute positively to society, yet these actions often go unnoticed, unmeasured, unanalysed, and/or undocumented in any systematic way.

Traditional sentiment analysis focuses on polarity (positive/negative), and reputation scoring is largely confined to consumer reviews or financial performance. There exists a growing need to recognize, analyse, document, compare, and quantify social good—especially in the form of expressed appreciation, community recognition, and acknowledgment of good deeds—across public digital platforms. Such a system could incentivize good behavior, support transparency, promote social good will, promote a positive image of a person or an entity, and enable new forms of socially conscious evaluation. In today's hyperconnected, data-saturated world, public expressions—ranging from gratitude and appreciation to criticism and rejection—play an increasingly vital role in shaping how society perceives the ethical, civic, or social value of individuals, organizations, governments, events, and ideas. These expressions form a complex, real-time layer of social accountability that remains largely unanalyzed by existing technologies.

Conventional tools in the domains of sentiment analysis, social listening, and reputation management are primarily designed for binary sentiment classification (positive vs. negative), customer feedback monitoring, or brand image tracking. These systems are ill-equipped to capture the intent, temporal significance, and contextual nuance embedded in more complex social cues—such as public gratitude, civic praise, ethical disapproval, or inferred acknowledgment of good or harmful conduct.

Moreover, existing Environmental, Social, and Governance (ESG) systems and Corporate Social Responsibility (CSR) frameworks rely heavily on self-reported data, formal disclosures, and static evaluations. They typically overlook unstructured public discourse, emergent perception shifts, and non-obvious social contributions or failures that manifest across digital ecosystems.

Millions of people, institutions, and even policies or products affect society in tangible ways—through Deeds that go recognized or unrecognized by the public. Yet no system currently exists that can dynamically quantify this social response in real time, trace it to specific actions or omissions, or forecast future behavior or response based on historical patterns.

There is therefore an unmet need for a system capable of detecting, classifying, analyzing and scoring Public Responses to Evaluable Subject(s) and/or Deed(s).

### BRIEF SUMMARY OF THE INVENTION

In one aspect, a computer system includes a transceiver for wireless or wired communication with a plurality of third party systems; at least one memory device; and at least one processing circuit, wherein the processing circuit is operatively coupled to the at least one memory device and wherein the at least one memory device stores instructions that, when executed by the at least one processing circuit, causes the computer system to: access, using the transceiver, data in the plurality of third party systems; search the data in the plurality of third party systems, using the at least one processing circuit, and collect data relating to an evaluable subject from the plurality of third party systems; identify in the collected data, using the at least one processing circuit, at least one deed of the evaluable subject, wherein the at least one deed includes at least one of: an action, behavior, communication, creation, event, existence and/or condition, of the evaluable subject; identify in the collected data, using the at least one processing circuit, one or more public responses associated with the at least one deed; generate, using the at least one processing circuit, a public response score using the one or more public responses associated with the at least one deed; and generate, using the at least one processing circuit, a graphical user interface displaying at least the public response score on a display of the computing system.

In another aspect, a computer system includes a transceiver for wireless or wired communication with a plurality of third party systems; at least one memory device; and at least one processing circuit, wherein the processing circuit is operatively coupled to the at least one memory device and wherein the at least one memory device stores instructions that, when executed by the at least one processing circuit, causes the computer system to: access, using the transceiver, data in the plurality of third party systems; search the data in the plurality of third party systems, using the at least one processing circuit, and collect data relating to an evaluable subject from the plurality of third party systems; identify in the collected data, using the at least one processing circuit, a plurality of public responses associated with the evaluable subject; generate, using the at least one processing circuit, a public response score using the plurality of public responses associated with the evaluable subject; and generate, using the at least one processing circuit, a graphical user interface displaying at least the public response score on a display of the computing system.

A method of a computer system, comprising accessing and searching, using at least one processing circuit of the computing system, data stored in a plurality of third party systems; and collecting from the plurality of third party systems, data relating to an evaluable subject. The method further includes identifying in the collected data, using the at least one processing circuit, at least one deed of the evaluable subject, wherein the at least one deed includes at least one of: an action, behavior, communication, creation, event, existence and/or condition, of the evaluable subject; identifying in the collected data, using the at least one processing circuit, a plurality of public responses associated with the at least one deed; generating, using the at least one processing circuit, a public response score using the plurality of public responses associated with the at least one deed; and generating, using the at least one processing circuit, a graphical user interface displaying at least the public response score on a display of the computing system.

In one or more of the above aspects, the plurality of third party systems includes two or more of: a social media system, a news website, a company website, a government website, a public forum, or a journal website.

In one or more of the above aspects, the computer system is further configured to determine a credibility score of the collected data associated with at least a first public response of the one or more public responses; determine a credibility score for the at least first public response using the credibility score of the associated collected data; and generate the public response score using the one or more public responses to the at least one deed and the credibility score.

In one or more of the above aspects, the computer system is further configured to identify in the collected data the at least one deed of the evaluable subject using one or more of: natural language processing or deterministic or heuristic rule-based logic.

In one or more of the above aspects, the computer system is further configured to identify in the collected data the one or more public responses to the at least one deed using one or more of: natural language processing, deterministic or heuristic rule-based logic, and sentiment analysis.

In one or more of the above aspects, the computer system is further configured to generate the public response score using the one or more public responses to the at least one deed by generating one or more of: a Positive Response Score; an Adverse Response Score; or a composite Gratitude Footprint.

In one or more of the above aspects, the computer system is further configured to generate the public response score using the one or more public responses to the at least one deed by weighting each of the one or more public responses, wherein the weighting is based on one or more of: sentiment polarity; credibility weighting; nature, of the deed; context of the deed; temporal decay or time-relevance adjustment; or thematic clustering.

In one or more of the above aspects, the computer system is further configured to identify, in the collected data, at least one deed of the evaluable subject by identifying an inferred deed that is not explicitly stated in the collected data, wherein the inferred deed is identified by using linguistic structures, discourse patterns, and/or narrative cues to identify the inferred deed from indirect references or outcomes.

In one or more of the above aspects, the computer system is further configured to obtain a data submission from an authenticated user of the computer system; verify the data submission; classify the data submission as representing a second deed of the evaluable subject or another public response of the at least one deed; and update the public response score using the classified data submission.

In one or more of the above aspects, the computer system is further configured to determine a credibility score for each of the plurality of public responses, wherein the credibility score for each public response is determined based on a credibility of the collected data associated with each public response; determine a weight to apply to each of the plurality of public responses using the credibility score for each public response; and generate the public response score using the plurality of public responses and the weight applied to each of the plurality of public responses.

In one or more of the above aspects, the computer system is further configured to perform temporal decay analysis or time-relevance adjustment to a weight applied to each of the plurality of public responses and generate the public response score using the plurality of public responses and the weight applied to each of the plurality of public responses.

In one or more of the above aspects, a method further includes determining a credibility score for each of the plurality of public responses; and generating the public response score using the plurality of public responses to the at least one deed and the credibility score for each of the plurality of public responses.

In one or more of the above aspects, a method further includes identifying in the collected data, using the at least one processing circuit, at least one deed of the evaluable subject comprises using one or more of: natural language processing or deterministic or heuristic rule-based logic.

In one or more of the above aspects, a method further includes identifying in the collected data, using the at least one processing circuit, a plurality of public responses associated with the at least one deed comprises using one or more of: natural language processing, deterministic or heuristic rule-based logic, and sentiment analysis.

In one or more of the above aspects, a method further includes modeling a historical relationship between the plurality of Public Responses and the at least one Deed within one or more thematic clusters of the Evaluable Subject; and predicting a future action and/or a future Public Response based on the historical relationship.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown,

FIG. 1 illustrates a schematic block diagram of a computing system environment including a gratitude system in accordance with one or more embodiments herein.

FIG. 2 illustrates a schematic block diagram of the gratitude system interworking with one or more third party systems in accordance with one or more embodiments herein.

FIG. 3 illustrates an exemplary embodiment of a notification database and data therein in accordance with one or more embodiments herein.

FIG. 4 illustrates a schematic block diagram of the gratitude system with a tiered architecture in accordance with one or more embodiments herein.

FIG. 5 illustrates a schematic block diagram of an exemplary graphical user interface (GUI) generated using the gratitude system in accordance with one or more embodiments herein.

FIG. 6 illustrates a schematic block diagram of another exemplary GUI generated using the gratitude system in accordance with one or more embodiments herein.

FIG. 7 illustrates a schematic block diagram of another exemplary GUI generated using the gratitude system in accordance with one or more embodiments herein.

FIG. 8 illustrates a schematic block diagram of another exemplary GUI generated using the gratitude system in accordance with one or more embodiments herein.

FIGS. 9A-9D illustrate schematic block diagrams of methods of the gratitude system in accordance with one or more embodiments herein.

FIG. 10 illustrates a schematic block diagram of another embodiment of a computing system environment including the gratitude system in accordance with one or more embodiments herein.

FIG. 11 illustrates a schematic block diagram of an embodiment of a user device in accordance with one or more embodiments herein.

FIG. 12 illustrates a schematic block diagram of another embodiment of a user device in accordance with one or more embodiments herein.

FIG. 13 illustrates a schematic block diagram of a scoring system in accordance with one or more exemplary embodiments.

FIG. 14 illustrates a schematic block diagram of the scoring application operating in the scoring system in accordance with one or more exemplary embodiments.

FIGS. 15A-15F illustrate schematic block diagrams of methods of the scoring system in accordance with one or more embodiments herein.

FIG. 16 illustrates a method of another embodiment of the generating a public response Score in the scoring system in accordance with one or more embodiments herein.

FIG. 17 illustrates a schematic block diagram of another embodiment of the scoring application operating in the scoring system in accordance with one or more exemplary embodiments.

### DETAILED DESCRIPTION OF THE INVENTION

The subject application references certain processes which are presented as a series of ordered steps. The steps described with respect to these processes are not to be understood as enumerated consecutive lists but could be performed in various orders and one or more steps may be removed or additional steps added while still embodying the invention described herein.

Where a term is provided in the singular, the inventors also contemplate aspects of the invention described by the plural of that term. As used in this specification and in the appended claims, the singular forms “a,” “an” and “the” include plural references unless the context clearly dictates otherwise, e.g., “an appliance” may include a plurality of appliances. Thus, for example, a reference to “a method” includes one or more methods, and/or steps of the type described herein and/or which will become apparent to those persons skilled in the art upon reading this disclosure.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods, constructs, and materials are now described. All publications mentioned herein are incorporated herein by reference in their entirety. Where there are discrepancies in terms and definitions used in references that are incorporated by reference, the terms used in this application shall have the definitions given herein.

### Gratitude System and Method

A gratitude system and method are described herein that is configured to generate, transmit, and track gratitude notices. The gratitude system, through a website or application, e.g., known as ThankApp™ or SuperThankApp™, includes a system and method for generating a gratitude notification, such as a Thank You note, to a recipient. The recipient may then agree for the gratitude notice to be posted to a social media service, e.g., Facebook®, Instagram®, LinkedIn®, TikTok®, and/or another social network. In one embodiment, the gratitude system communicates with the social network to post the gratitude notice. In another embodiment, the gratitude system is incorporated into the social network as an enhanced feature. The gratitude system also stores the plurality of generated gratitude notices in a public database that may be accessed and searched by a user. Thus, a user may search the database and obtain the gratitude notices sent by a particular sender or received by a particular recipient. The gratitude application may be a web-based application supported by an application web server that provides access to the gratitude application, e.g., online via a website. In another embodiment, the gratitude system includes a stand-alone application that is downloaded to a user device and is operable on a user device without access to the application web server or only needs to access the application web server or other devices for additional data and updates.

In use, in one exemplary embodiment, a sender (individual, nonprofit, political campaign, alumni association, company, organization, etc.) accesses the gratitude system, through a website or downloaded application, and generates a gratitude notification to a recipient. The gratitude system electronically transmits the gratitude notification to the recipient (individual, nonprofit, political campaigns, alumni association, company, organization, etc.) using contact information for the recipient, such as a text, email, Facebook account, Instagram account, or LinkedIn account. The gratitude notification includes an option to select a permission level to specify whether the gratitude notice, or data elements thereof, may be published on third party applications, such as Facebook, Instagram, LinkedIn and/or on a website for the gratitude system. If allowed by the selected permission level, the gratitude notification is posted on one or more social networks or the gratitude system website such that those accessing the social media of the recipient may view the gratitude notification. The gratitude notification may include one or more hyperlinks to retrieve more detailed information related to the gratitude notification. Thus, the gratitude system provides a public platform for those who wish to express and receive gratitude while also maintaining privacy for those who wish to remain anonymous.

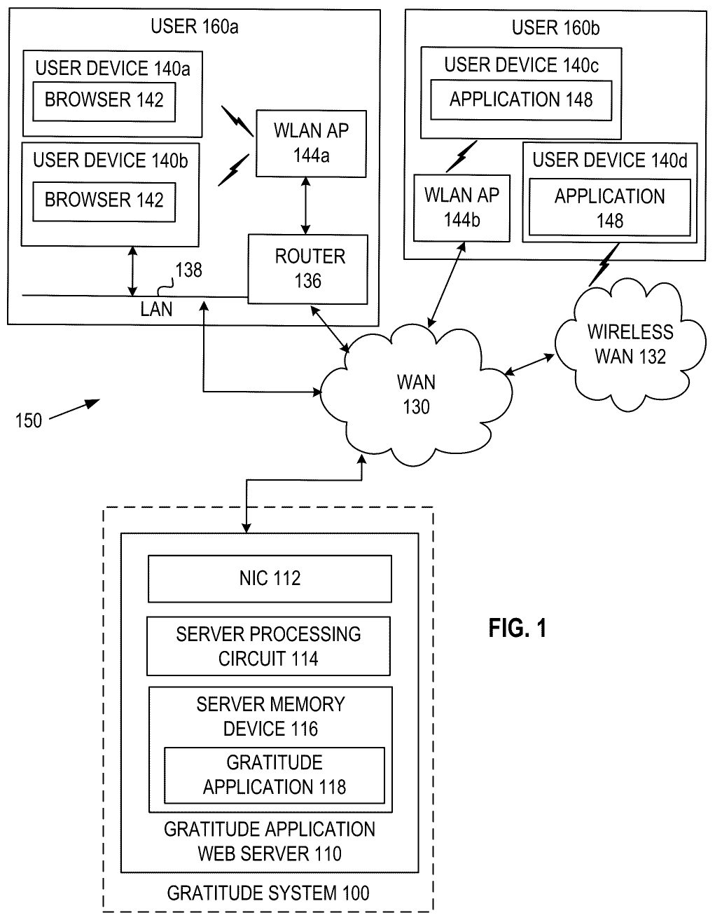

Referring now to FIG. 1, it illustrates a schematic block diagram of a computing system environment 150 including the gratitude system 100 in accordance with one or more exemplary embodiments. The gratitude system 100 includes at least one gratitude application server 110 configured to provide, e.g., a cloud-based application or service that allows access to the gratitude system 100 by browsers 142 on one or more user devices 160a-b via a wide area network (WAN) 130 or wireless WAN 132. The user devices 140a-d include any type of processing device, such as a smartphone, laptop, desktop, tablet, watch, television, vehicle, etc. The user devices 140a-d may also include user interface devices, such as keyboard, mouse, pen, voice input device, touch input device, a display, speakers, printer, etc. As used herein, the users 160a-b of the gratitude system 100 may include one or more of individuals, company, non-profit group, political party, or other organization that uses or licenses the gratitude system 100.

In one embodiment, the users 160a-b operate the user devices 140 to access the gratitude system 100 using a web browser 142, such as Goggle Chrome®, Microsoft Edge®, Apple Safari®, etc. The one or more web browsers 142 interact with the application web server 110 of the gratitude system 100 using one or more protocols. For example, the browsers 142 may submit HTTP or other type of protocol request messages to the application web server 110. The application web server 110 provides resources such as HTML files, data or other content and returns a response message to the browser 142. The browser 142 then displays the HTML files, data, or other content to the user 160a on the user device 140a-d as one or more graphical user interfaces (GUIs).

In another exemplary embodiment, a user application 148 may be downloaded from the application web server 110 and installed on the user devices 140a-d. The user application 148 may be operable on a user device 140a-d without access to the application web server 110 and/or communicate with the application web server 110 or other server for updates, data, content, or certain processes. For example, a standard client server technology architecture may be implemented, which allows users 160a-b of the gratitude system 100 to access information stored in the databases of the application web server 110 or other servers via custom user interfaces. Communication between software components and sub-systems are achieved by a combination of direct function calls, publish, and subscribe mechanisms, stored procedures, and direct SQL queries, however, alternate components, methods, and/or sub-systems may be substituted without departing from the scope hereof. Also, alternate embodiments are envisioned in which the user devices 140a-d may access one or more servers through a private network. The user devices 140a-d may host the private network with a server or other device including a client version of the gratitude system 100.

The computing system environment 150 includes a combination of one or more networks that are communicatively coupled to the gratitude system 100 and the user devices 140a-d, e.g., such as a wide area network (WAN) 130 or a wireless wide area network (Wireless WAN) 132. The WAN 130 includes the Internet, service provider network, other type of WAN, or a combination of one or more thereof. The Wireless WAN 132 includes a cellular network, such as a 4G or 5G network. The WAN 130 or Wireless WAN 132 are communicatively coupled directly to a user device 140a-d or coupled to the user devices 140a-d through an edge network, e.g., including a router 136, bridge (not shown), or other devices. The client router 136 may be coupled to a local network, including e.g., a local area network (LAN) 138 or WLAN access point (AP) 144a-b. The one or more networks work to communicatively couple the user devices 140a-d to the gratitude system 100. Alternate networks and/or methods of communicating information may be substituted without departing from the scope hereof.

The application web server 110 includes, e.g., a network interface card (NIC) 112 that includes a wired and/or wireless transceiver for wireless and/or wired network communications with one or more of the user devices 140a-d over the exemplary networks 130, 132 in the computing environment 150. The NIC 112 may also include authentication capability that requires an authentication process prior to allowing access to some or all the resources of the application web server 110. The NIC 112 may also include firewall, gateway, and proxy server functions.

The application web server 110 also includes a server processing circuit 114 and a server memory device 116. The server memory device 116 is a non-transitory memory device and may be an internal memory or an external memory. The memory device 116 may be a single memory or a plurality of memories. The memory device 116 may be a read-only memory, random access memory, volatile memory, non-volatile memory, static memory, dynamic memory, flash memory, cache memory, and/or any non-transitory memory device that stores digital information. The server processing circuit 114 includes at least one processor, such as a central processor unit (CPU), microprocessor, microcontroller, embedded processor, digital signal processor, media processor, field programmable gate array, programmable logic device, state machine, logic circuitry, analog circuitry, digital circuitry, and/or any device that manipulates signals (analog and/or digital) based on hard coding of the circuitry and/or operational instructions. The server memory device 116 stores computer-executable instructions which when executed by the server processing circuit 114, causes the gratitude system 100 to perform one or more functions described herein. For example, the server memory device 116 stores a gratitude application 118 including at least a portion of computer-executable instructions executed by the gratitude system 100 to perform the functions described herein.

The depicted computing system environment 150 is only one example of a suitable computing environment and is not intended to suggest any limitation as to the scope of use or functionality. Numerous other general purpose or special purpose computing system environments or configurations may be used. Examples of well-known computing systems, environments, and/or configurations that may be suitable for use include, but are not limited to, personal computers (“PCs”), server computers, handheld or laptop devices, multi-processor systems, microprocessor-based systems, network PCs, minicomputers, mainframe computers, cell phones, tablets, embedded systems, distributed computing environments that include any of the above systems or devices, and the like. The servers, memory devices, processing circuits, NICs, user devices, routers, and other network components shown in FIG. 1 are merely exemplary, and one or more devices may be omitted, added, or substituted without departing from the scope of the present invention,

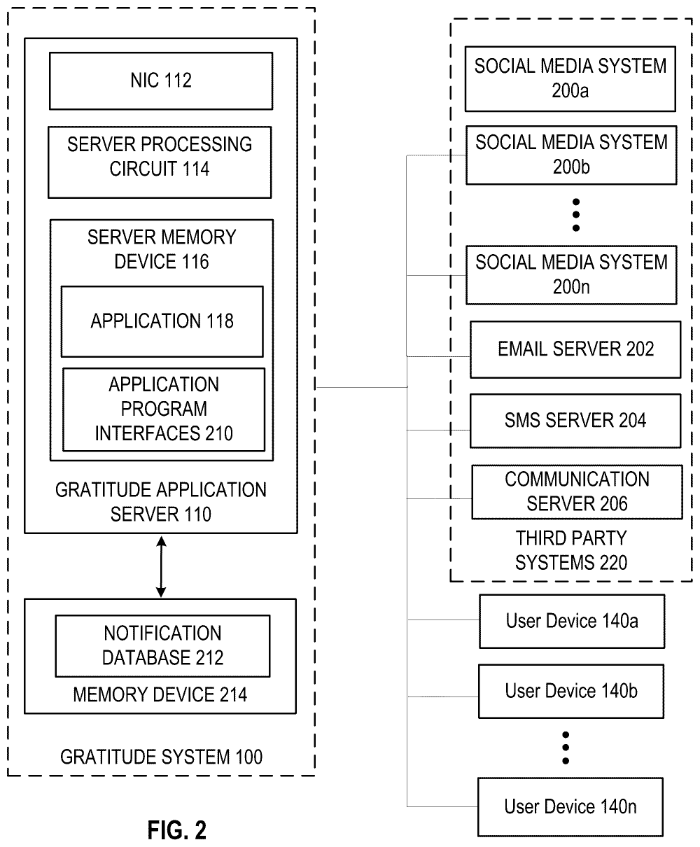

FIG. 2 illustrates a schematic block diagram of the gratitude system 100 interworking with one or more third party systems 220 in accordance with one or more exemplary embodiments. The gratitude system 100 includes application program interfaces (APIs) 210 configured to access one or more of third-party systems 220. The third-party systems 220 may include third party application servers, websites, services, databases, devices, and/or networks. In one embodiment, the third-party systems 220 include one or more social media systems 200a-n, such as LinkedIn®, Facebook®, Instagram®, TikTok®, X™ (aka, Twitter®), Snapchat®, etc. Additional and/or alternate social media systems or applications may also be accessed by the gratitude system 100. The gratitude system 100 may also access email servers 202 and/or a short message service (SMS) server 204, or instant messenger (IM) servers, or other communication applications servers 206, such as WhatsApp®, Skype®, Snapchat®, etc.

The gratitude system 100 further communicates with the one or more user devices 140a-b, as described with respect to FIG. 1. The users 160 may access the gratitude system 100 using the user devices 140a-b to perform one or more functions described herein. The users 160 can optionally create user profiles in the gratitude system 100 and/or social media systems 200a-n including associated contact data, such as email, text, phone number, social network accounts, physical address, etc. The user profiles may be associated with an individual user, a company, non-profit, school, retail, political party, government agency, informal group (such as a book club or child's sports team), or other public or private organization.

The gratitude system 100, e.g., through its website or application, provides users 160a-b with the ability to send and receive gratitude or thank you notifications to a recipient. Furthermore, with appropriate permissions, the gratitude notifications may be posted or viewable publicly on one or more selected social media systems 200a-n and/or a website operated by the gratitude system 100. For example, a user 160 may generate a gratitude notification using the gratitude system 100 and have the gratitude notification transmitted to a recipient via email, text, IM, notification in a Facebook account, direct message (DM) on Instagram, a Snapchat, or other social media account of the recipient, etc. When permission is granted by the sender and the recipient, the gratitude system 100 may post the gratitude notification on one or more of the social media accounts of the sender and/or of the recipient. Thus, the public may view the gratitude notification on the one or more social media accounts when permitted by the sender and the recipient. In addition, the gratitude system 100 may post the gratitude notification on a website operated by the gratitude system 100. The gratitude system 100 thus provides users 160, such as nonprofits, GoFundMe® causes, alumni associations, etc., the ability to thank donors publicly and thereby publicize their cause and possibly obtain more potential donors.

In addition, the gratitude system 100 may maintain a notification database 212 in a memory device 214 that includes the gratitude notifications and data associated therewith. The memory device 214 may be a separate memory device from the application web server 110 or incorporated into the application web server 110. In an embodiment, the gratitude system 100 provides public access to at least a portion of the data in the notification database 212. For example, when permission is granted by the sender and recipient of a gratitude notification, the gratitude notification, or portions thereof, may be accessed and searched in the database 212. The gratitude system 100 may provide a website or other public or private portal to access and search a public portion of the notification database 212. For example, the website may allow a public search for gratitude notifications generated for a particular individual recipient or organization. In response to the search request, the application web server 110 accesses the notification database 212 and provides a list of the publicly available gratitude notifications that meets the search criteria. Thus, the various acts of kindness and generosity performed by a person or organization may be searched and viewed. This ability may be valuable to potential employers deciding on whether to hire an individual or to colleges as part of the admission process or organizations determining an award recipient.

In addition, an individual or organization may search the notification database 212 and determine notifications generated by themselves over a time period. For example, at the end of the year, a user 160 may obtain a list of recipients of gratitude notifications from the user to identify persons who have helped the user through the year and ensure to wish them happy holidays.

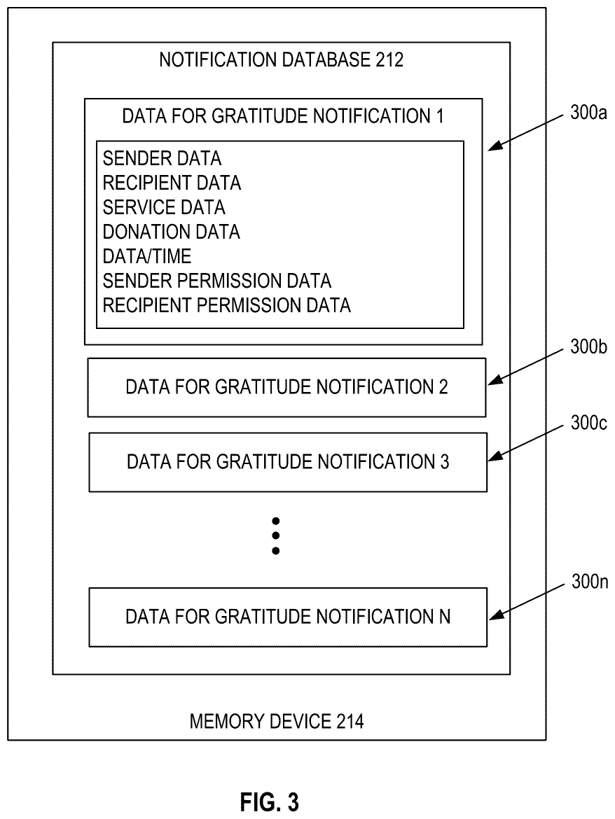

FIG. 3 illustrates an exemplary embodiment of a notification database 212 and data elements therein in accordance with one or more embodiments of the present invention. The notification database 212 may be stored in one or more memory devices 214 and may comprise multiple databases or data structures. The notification database 212 may include one or more databases capable of storing, organizing, sorting, filtering or otherwise manipulating data, including without limitation cloud-based databases, and may be included within or connected to one or more servers as described herein in any appropriate manner without departing from the scope hereof. In one embodiment, the notification database 212 may include a public portion with data accessible by the public and a private portion with data only accessible to the sender and/or recipient of a particular gratitude notification. The private portion and the public portion of the notification database 212 may be stored on a same device or different devices or multiple devices.

The data 300a-n associated with a gratitude notification and stored in the notification database 212 includes a plurality of fields, for example, sender data and recipient data. Individual data fields may include a name, email, phone number, one or more social media accounts, a physical address, etc. In some cases, the sender and/or receiver data includes account information for the gratitude system 100. For example, a user may be required to create a user account, e.g., with at least an email address and password, to generate a gratitude notification. However, a recipient may not be required to have a user account with the gratitude system 100 to receive the gratitude notification. The sender may input an email, phone number, Facebook account, WhatsApp number, or other contact data associated with the recipient. The recipient may thus receive the gratitude notification without creating a user account with the gratitude system 100.

The data 300a-n associated with a gratitude notification and stored in the notification database 212 may further include service data and/or donation data. The service and/or donation data elements include a description of the act of kindness, monetary donation, in-kind donation, or other reason for the gratitude notification. The data 300a-n associated with a gratitude notification and stored in the notification database 212 may also include a date and time that the gratitude notification was generated and/or when it was transmitted and/or when it was acknowledged, etc.

The data 300a-n associated with a gratitude notification and stored in the notification database 212 may further include sender and recipient permission data. The permission data includes one or more permission levels specified by the sender and/or recipient. The permission level defines whether the gratitude notification may be published publicly, e.g., on a social network, and/or accessed publicly through the website of the gratitude system 100. In some embodiments, the permission level may specify that some data fields associated with a gratitude notification may be published and/or publicly accessible while other data fields associated with the gratitude notification are to remain private. For example, a recipient may allow publication on a social network of the gratitude notification for a donation to a charity but request that the amount of the donation remain private. In another example, a sender may wish to acknowledge a recipient's help during an illness but prefers that their illness remain confidential. The sender may then specify for the service data to remain private or that only a generic descriptor, such as “Act of Kindness”, is published and/or publicly accessible. The permission levels may include publicly available, private to only the sender/recipient, available only to users of the gratitude system 100 having user accounts, available only to specified users of the gratitude system 100, available only to “friends” of sender and/or receiver on a social media system, etc. The sender and the recipient may thus control the accessibility of the data associated with the gratitude notification.

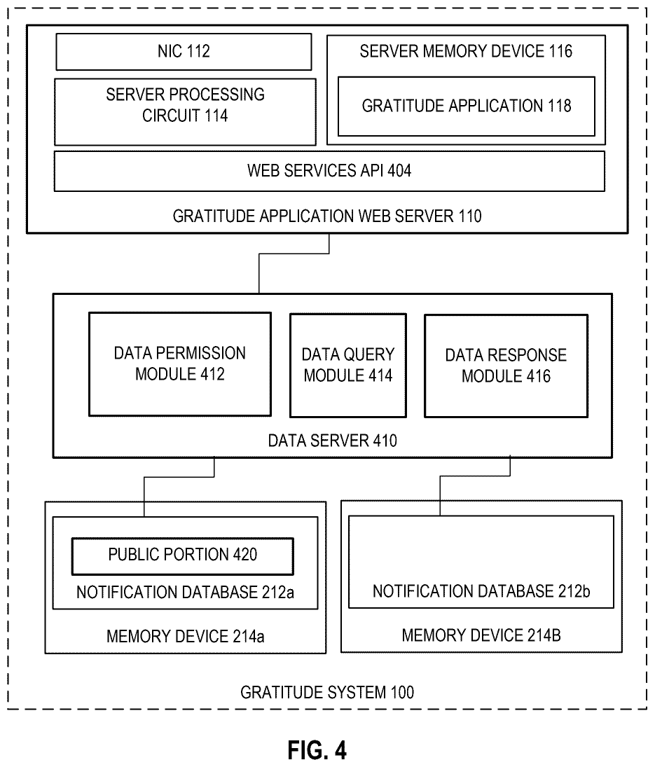

FIG. 4 illustrates a schematic block diagram of a gratitude system 100 with a tiered architecture for providing a website in accordance with one or more embodiments herein. In some embodiments, the gratitude system 100 hosts a web-based or cloud-based gratitude application 118 that allows access to the gratitude system 100 using a web browser 142 on one or more user devices 140. For example, the web browsers 142 allow the user devices 140 to interact with the application web server 110 via a Hypertext Transfer Protocol (“HTTP”) or other similar protocol. The application web server 110 handles the HTTP requests and provides content such as images, CSS, JavaScript files, HTML files, or other files to the browsers 142. The application web server 110 may transmit one or more HTML files or other types of files and/or transmit other data or content to the browsers 142. The browsers 142 generate one or more graphical user interfaces (GUI) using the files and data from the application web server 110. The NIC 112 on the application web server 110 includes a wireless and/or wired transceiver with authentication capability that requires an authentication process prior to allowing access to some or all the resources of the gratitude system 100, such as a login with a username and password, biometric identification, or other verification process. The NIC 112 may also include firewall, gateway, and proxy server functions. The application web server 110 also includes the gratitude application 118 which is a custom application built using a programming language like Python, Java, or Ruby.

The application web server 110 communicates over a private network with the data server 410. The data server 410 manages the notification database 212a-b. In an embodiment, the notification database 212a-b is stored as one or more databases on the one or more memory devices 214a-b. The memory devices 214a-b may be included as part of the data server 410 or may be separate devices.

This tiered architecture is more secure because the user devices 140a-n do not directly access the data in the data server 410 or memory devices 214a-b. The web services API 404 provides an interface for communication between the application web server 110 and the data server 410. The data server 410 may then access any requested data in the notification database 212a-b and provide the requested data to the application web server 110, e.g., for communication to the user devices 140. The data server 410 may include a data permission module 412 that determines the permission level for a data field and may store public data fields in a separate public portion 420 of the notification database 212a-b. Thus, data fields with a restricted permission level are separated and more secure. A data query module 414 may receive the data request from the web services API 404 and generate a search or data filter for searching the notification database 212a-b. The data response module 416 may receive the search results and generate a response to the web services API 404.

The servers, memory devices, and databases shown in FIG. 4 are merely exemplary, and servers and/or databases may be omitted, added, or substituted without departing from the scope of the present invention. In addition, different system architectures may be implemented that perform the functions described herein. The gratitude system 100 thus provides a special purpose computing system configured for provision of the new methods and functions described herein. The gratitude system 100 includes significant additional elements with tangible physical form and provides a practical application for performing one or more unique methods described herein that may only practically be performed by a computing system, considering the multitude of data, e.g., of the plurality of users, of the plurality of gratitude notifications, database management, and the generation of computer implemented interfaces with new functionality and communications with remote, third party processing devices.

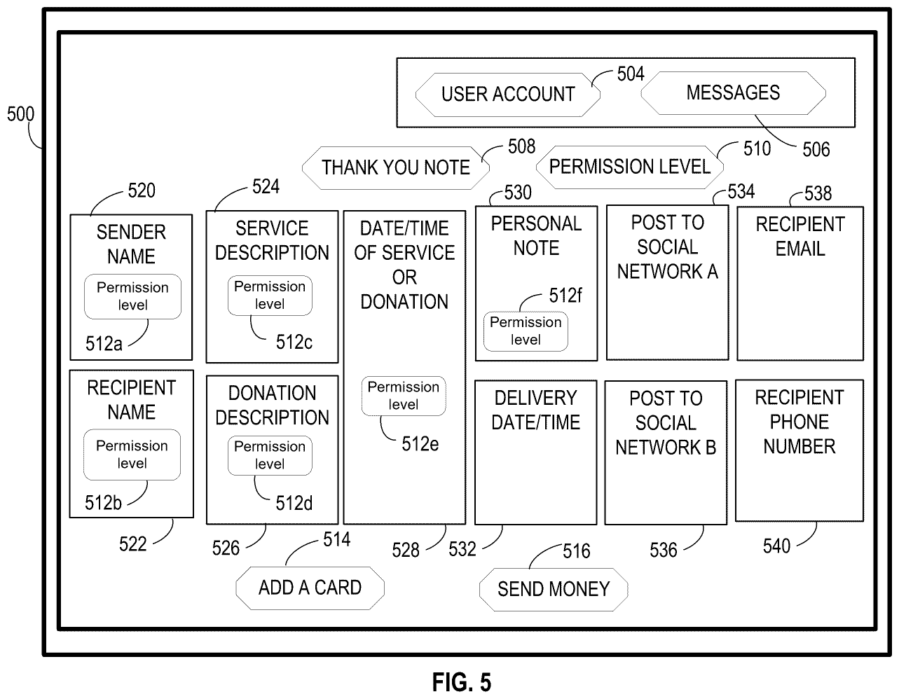

FIG. 5 illustrates a schematic block diagram of a graphical user interface (GUI) 500 that may be generated using the gratitude system 100 and displayed on one or more user devices 140a-d in accordance with one or more embodiments herein. The GUI 500 is merely exemplary to illustrate types of data fields displayed and functionality of the gratitude system 100. The fields, icons and data described with respect to this GUI 500 may be included on additional and/or alternate GUIs or in other ways than described herein.

In this exemplary GUI 500, a user may input data to generate a gratitude notification, e.g., a Thank you note. The GUI 500 may include a user account icon 504 that displays a current user of the gratitude system 100 that has logged into their user account. The GUI 500 may further include a messages icon 506 that when selected, displays messages for the user. These messages may include acknowledgement of prior gratitude notifications sent by the user, a notice that the user has received a gratitude notification, etc.

The GUI 500 indicates that a Thank You note (i.e., gratitude notification) has been selected with icon 508. Other types of notifications may be generated in one or more embodiments, such as Acknowledgements of a Thank You note, Congratulation notifications, Award notifications, etc. The GUI 500 further includes a permission level icon 510 to select whether the gratitude notification may be published and publicly available. The permission levels may include “private” or “public” or only “Friends” of the sender or other defined level. When private is selected, the gratitude system 100 will not post the Thank You note, or any data associated with the Thank You note, on a social network or its website. In addition, the gratitude system 100 will not allow access to the gratitude notification in its notification database 212 except by the sender and the recipient. Thus, other users may not view the gratitude notification in response to a search of the notification database 212. In addition to private or public, the permission levels may further include one or more of: only registered users of the gratitude system 100, only friends on a social network, only specific users of the gratitude system 100, or other defined levels.

The GUI 500 includes a plurality of data elements for the sender to complete including one or more of the following: sender name 520, recipient name 522, service description 524, donation description 526, data/time of the service/donation 528, and/or a personal note 530. The GUI 500 may provide suggestions for completing various fields. For example, for the donation/service description, the gratitude system 100 may suggest “Act of Kindness” or “Kind Words” or “Thoughtful Gift”, or “Generous Donation”, etc.

In addition, one or more of the data fields have an associated permission level icon 512a-f. The user may select the icons 512a-f to specify a permission level for the associated data field. For example, when a sender is thanking the recipient for flowers in the hospital, the sender may want their name to remain anonymous for medical privacy. The sender may then select the permission level icon 512a associated with the data element “Sender Name.” In response, the GUI 500 displays a drop-down menu including different permission levels. The sender may then select “Private” as the permission level for the data element “Sender Name”. The sender may select that the other data elements have a permission level of “Public” using the other icons 512b-f, so that others may know the recipient performed the kind act of sending flowers to “anonymous” in the hospital. The sender may thus control the permission level and accessibility of individual data elements of the Thank You note prior to sending to the recipient.

The GUI 500 may further include data fields 534, 536 to indicate which Social Networks to post the gratitude notification and data fields to insert contact information for the recipient including recipient email 538, recipient phone number 540, or other contact information, such as one or more social network user ids, IM, etc. The sender may also specify a delivery data/time 532 of the gratitude notification. For example, the sender may prepare Thank You notes to hosts of an event and delay the delivery until after the event. The GUI 500 may further include an icon 514 with a hyperlink to a GUI to generate an electronic card (eCard) and have the eCard attached to the Thank You note. The GUI 500 may further include an icon 516 to an application to send money, such as PayPal® or Zelle® or Venmo®. The GUI 500 may also include additional and/or alternate data fields, menus, icons, etc. to those described herein.

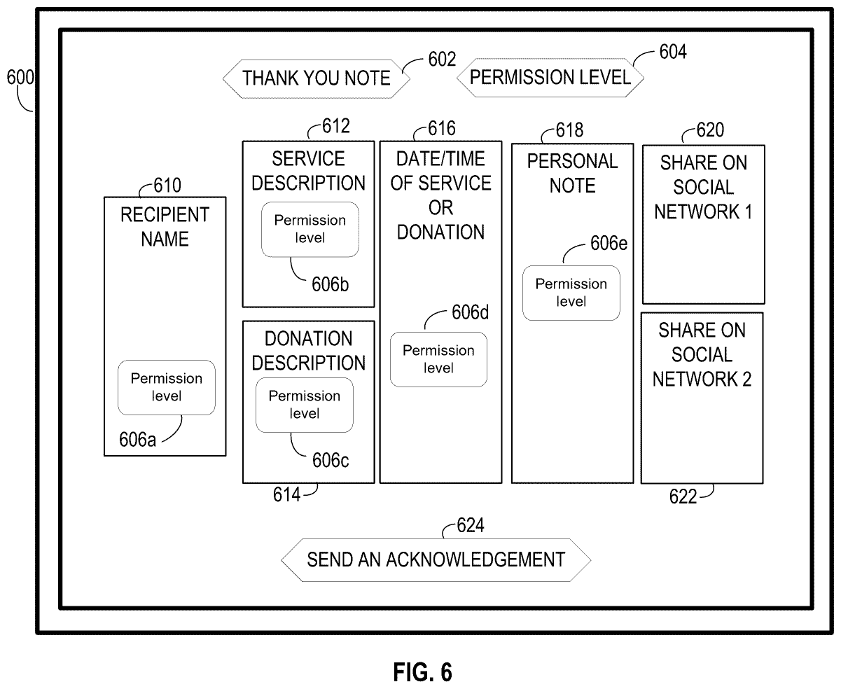

FIG. 6 illustrates a schematic block diagram of a graphical user interface (GUI) 600 that may be generated using the gratitude system 100 and displayed on a user device 140 in accordance with one or more embodiments herein. The GUI 600 is merely exemplary to illustrate types of data displayed and functionality of the gratitude system 100. The fields, icons and data described with respect to this GUI 600 may be included on additional and/or alternate GUIs or in other ways than described herein.

In this exemplary GUI 600, a gratitude notification, i.e., a Thank You note 602, are displayed on a recipient device 140. The recipient may receive an alert through email, text, an icon or notification on a Facebook page, Instant Messenger, etc. that the recipient has received a Thank You note. When an icon in the alert is selected by the recipient, it activates a hyperlink with the IP address to the application web server 110 for the gratitude system 100 and/or to a particular page of a website generated by the application web server 110 that displays the Thank You note. The recipient may then view the details of the Thank You note, e.g., as shown in FIG. 6.

In an embodiment, the GUI 600 includes one or more “Share on Social Network” icons 620, 622. When the recipient wants to post the Thank You note to a social media system 200a-n, the recipient may select one or more of the “Share on Social Network” icons 620, 622. When selected, the gratitude system 100 may request a user ID/login for the recipient on the social network if not already known. The gratitude system 100 will then communicate with the social network as described with respect to FIG. 2 to post the Thank You note to the recipient's account on the selected one or more social media systems 200a-n.

When the recipient prefers that the Thank You note remain private, the recipient may select the permission level icon 604 associated with the gratitude notification and then select “Private”. When private is selected, the gratitude system 100 will not post the Thank you note, or any data associated with the Thank You note on a social media system 200a-n or its website. In addition, the gratitude system 100 will not allow the gratitude notification to be publicly accessible in its notification database 212, except for the sender and the recipient. Thus, third party users may not view the gratitude notification in response to a search of the notification database 212. The permission levels may further include one or more of: only registered users of the gratitude system 100, only friends on a social network, only specific users of the gratitude system 100, etc.

The GUI 600 may further include permission level icons 606a-e associated with particular data fields in the Thank You note, such as the recipient's name 610, service description 612, donation description 614, date/time of the service/donation 616, or the personal note 618. The recipient may select a permission level for one or more of the plurality of data fields. For example, the Thank You note may specify a monetary amount in the donation description data field 614. The recipient may select “Private” as the permission level 606c for the donation description data field 614 so that the amount of the donation is not published or accessible. When the gratitude system 100 transmits the gratitude notification to a social network, it will not include the donation description data field 614. Instead, it may only provide a generic description of “A Donation”. In addition, the gratitude system 100 will not make the donation description data field 614 publicly available in its notification database 212, except for the sender and the recipient. Thus, users may view the gratitude notification, but not the donation description data field 614, in response to a search of the notification database 212. In another example, the recipient may select “Private” as the permission level for the personal note data field 618 so that the personal note from the sender is not published or accessible. When the gratitude system 100 transmits the gratitude notification to a social network, it will not include the personal note data field 618. In addition, the gratitude system 100 will not make the personal note data field 618 publicly available in its notification database 212, except for the sender and the recipient. Thus, third party users may view the gratitude notification, but not the personal note data field 618, in response to a search of the notification database 212. The recipient is thus able to control the accessibility of individual data elements of the Thank You note while still posting the Thank You note to social networks and to the gratitude system website.

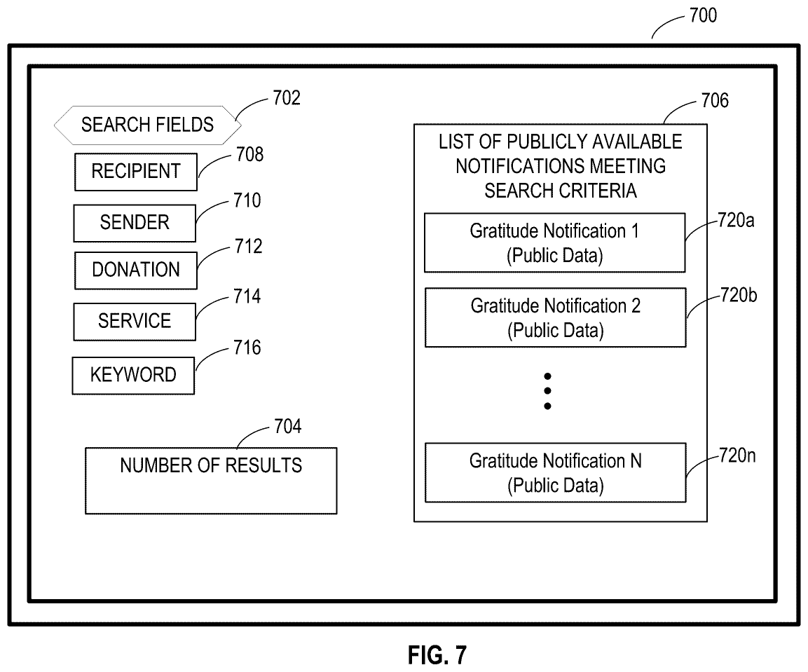

FIG. 7 illustrates a schematic block diagram of a graphical user interface (GUI) 700 that may be generated using the gratitude system 100 and displayed on a user device 140a-d in accordance with one or more embodiments herein. The GUI 700 is merely exemplary to illustrate types of data displayed and functionality of the gratitude system 100. The fields, icons and data described with respect to this GUI 700 may be included on additional and/or alternate GUIs or in other ways than described herein.

In this exemplary GUI 700, the gratitude system 100 generates an interface to the notification database 212 including a search tool for users to search for gratitude notifications that have been generated by the gratitude system 100 and stored in the notification database 212. One or more search fields 702 may be selected using the GUI 700. For example, the search fields 702 include one or more of recipient 708, sender 710, donation 712, service 714, keyword 716, etc. In response to the search request, the gratitude system 100 searches the notification database 212 for gratitude notifications that meet the requested search fields. The gratitude system 100 may determine and display a number of results 704 that are publicly available that meet the criteria. In another embodiment, the gratitude system 100 may also determine and include in the display the number of results that are not publicly available and cannot be accessed. Thus, a user may determine that additional acts of kindness were performed by a recipient but were selected to remain private.

A list 706 of the publicly available notifications 720a-n that meet the search criteria are displayed. The display may further include hyperlinks to view more details of each of the gratitude notifications. When displaying a gratitude notification, the gratitude system 100 only provides access to data elements associated with the gratitude notification that have a permission level that is “public” or other permission level that includes the user.

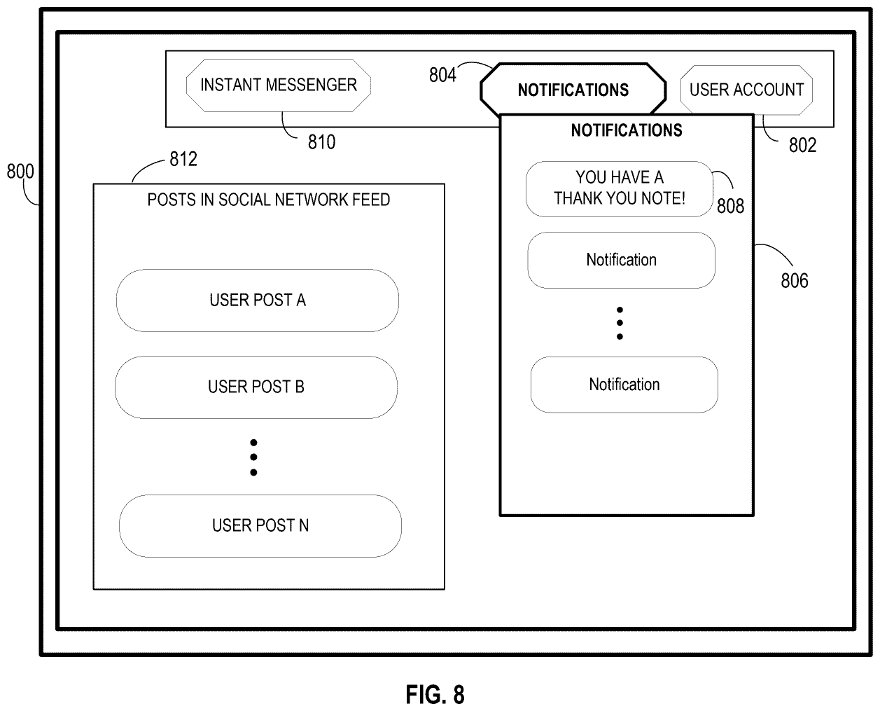

FIG. 8 illustrates a schematic block diagram of an exemplary GUI 800 for interworking with a social media system 200a-n by the gratitude system 100. In an embodiment, the gratitude system 100 obtains input data from a sender for a gratitude notification, such as a Thank You note, to transmit to a recipient via a social media system 200a-n. The gratitude system 100 communicates with the social media system 200a-n to generate an instant messenger (IM) message or other type of notification of the Thank You note to the recipient. The social media system 200a-n then generates a GUI 800 when the recipient logs into their user account 802. The GUI 800 includes, e.g., a list or feed of posts 812 from various users of the social network. The GUI 800 illustrates the IM icon 810 and a notifications icon 804 that when selected, generates a display 806 of messages or notifications including the notification 808 of the Thank You note.

The recipient may then select the notification 808 and view the Thank You note, e.g., either in the social media system 200a-n or through a hyperlink to the website of the gratitude system 100. The recipient may then select a permission level for the Thank You note and/or permission levels for the one or more individual data elements. The recipient may thus choose to post the Thank You note to their account in the social media system 200a-n and/or to other social media systems 200a-n. Though a notification 808 of the Thank You note is provided in this example, the Thank You note may be communicated as a message in Instant Messenger 810 or via email or via text or through other communication application.

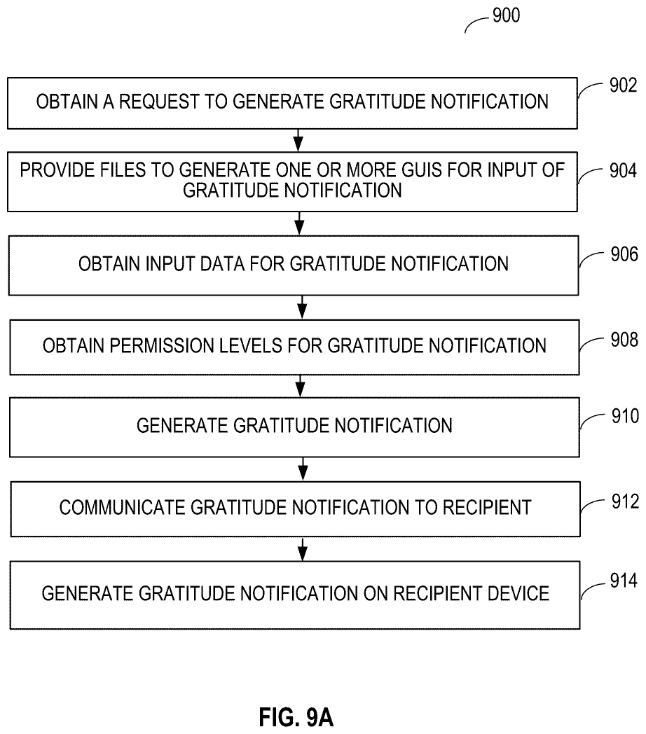

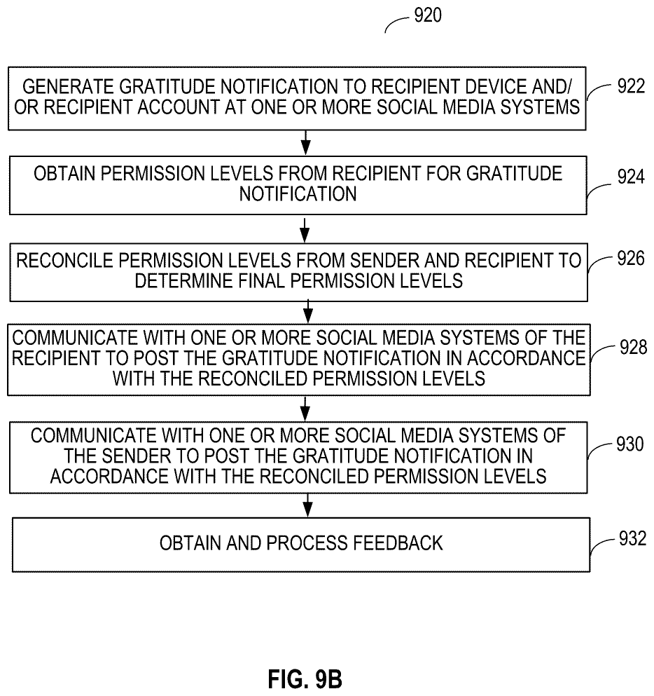

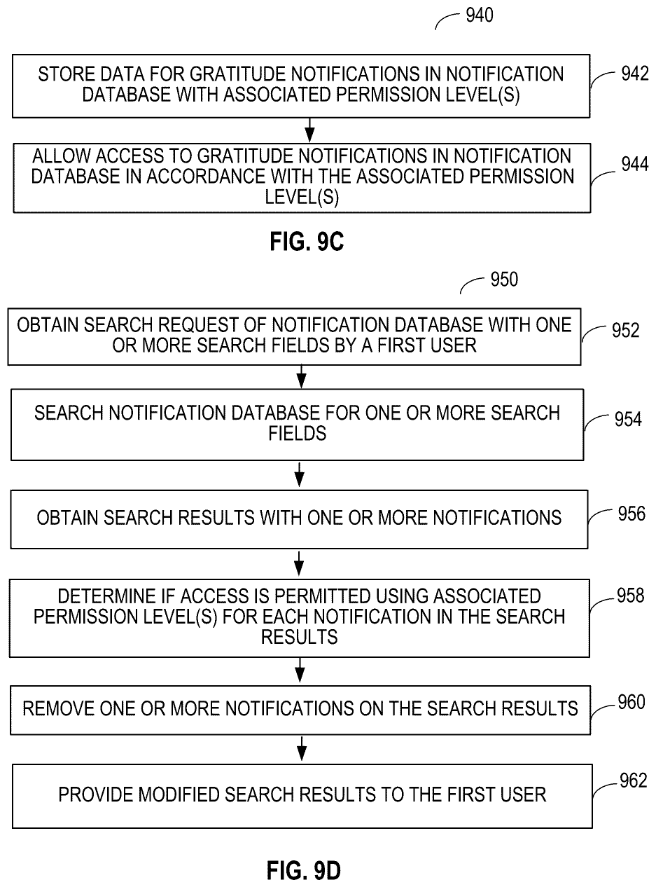

FIGS. 9A-D illustrate schematic block diagrams of methods of the gratitude system 100 according to one or more embodiments herein. Though the steps in the methods are illustrated as a sequential process, the steps may be performed in parallel or concurrently or may be re-arranged. Additional and/or alternate steps may also be performed as part of the methods. The methods may be performed using one or more of: an application 148 installed on a user device 140 or by the application web server 110 interacting with a web browser 142 on a client device 140 or by the application web server 110 interacting with a client application installed on a user device 140 or using other devices and configurations.

Referring to FIG. 9A, a method 900 is described for generating a gratitude notification. The gratitude system 100 obtains a request to generate a gratitude notification, e.g., from a registered user. The gratitude notification may include a Thank You note, Award notification, Congratulations notification, etc. In response, the gratitude system 100 generates HTML or other web files and transmits to a user device 142 at 904. The user device 140 uses the web files to generate one or more GUIs on the user device 142 of the registered user using an application 148 on the user device 140 or using a web browser 142 on the user device 142 or otherwise. The one or more GUIs include data fields or menu selections to receive user inputs of data elements for the gratitude notification. The data elements may include a sender name, recipient name, donation/service description, personal note, date/time, or other information, as described with respect to FIG. 5. In addition, the one or more GUIs include data fields or menu selections to receive user inputs of a permission level for the one or more data elements and/or for the entirety of the gratitude notification.

The data inputs for the gratitude notification are obtained at step 906, and the permission levels for the gratitude notification are obtained and processed at 908. The gratitude notification is generated at step 910, e.g., by an application 148 on the user device 140 or an application web server 110 or otherwise. In some implementations, the gratitude system 100 may include a sentiment analysis module employing a trained natural language processing (NLP) engine. Upon receipt of unstructured textual input from a sender (e.g., a freeform thank-you message in the personal note field), the engine classifies the sentiment into one or more categories such as “joyful,” “appreciative,” “solemn,” or “celebratory.” Based on this sentiment classification, the system dynamically applies a matching visual or stylistic theme to the gratitude notification. Themes may include variations in font style, background imagery, color palette, or animation. In an embodiment, the NLP engine is also configured to suggest alternate phrasings of the sender's message to conform with a selected tone preference. Tone presets may include “formal,” “casual,” “playful,” or “professional.” Suggestions may be generated using transformer-based models trained on a corpus of thank-you messages and social expressions, and may be presented as editable drafts for the sender's confirmation.

The gratitude notification is electronically transmitted at step 912 to the recipient using email, text, instant messenger (IM), or through a notification or message in one or more social media systems 200a-n. The recipient views the gratitude notification, e.g., by selecting a hyperlink that downloads one or more web files at 914 or using the gratitude application 118 on the recipient's user device 140a-d. The user device then generates the gratitude notification GUIs, e.g., using the web files and a web browser 142.

FIG. 9B illustrates a method 920 for posting a gratitude notification to a user account on a social media system 200a-n. The gratitude notification transmitted to a recipient includes one or more prompts or icons to select a permission level for the gratitude notification and/or permission levels for the one or more individual data elements, e.g., as shown with respect to FIG. 6. The one or more GUIs also display the sender's selected permission levels, as the default. The recipient can then select additional permission levels or more restrictive permission levels at 924.

The gratitude system 100 then reconciles the permission levels from the sender and the recipient at 926, e.g., by selecting the more restrictive permission level. For example, when the sender selected “Public” as a permission level for a data element, but the recipient selected “Private” for the data element, then the more restrictive permission level of “Private” is determined for the data element. In another embodiment, the gratitude system 100 includes a context-aware privacy module configured to enhance the reconciliation of sender and recipient permission levels. This module may ingest contextual metadata including, but not limited to, the time of day, the type of device used to submit the gratitude notification (e.g., mobile vs. desktop), geolocation information, or inferred emotional context from message tone. In other embodiments, a machine learning model may infer recipient preferences in cases where explicit permission levels are not provided. The inference may be based on the recipient's historical approval behavior, social graph proximity, or prior engagement with similar notifications. For example, if a recipient has previously accepted public sharing of gratitude notifications from specific senders or during specific events, the system may use that data to assign a provisional permission score. A predictive consent engine may optionally be implemented using a classification model trained to estimate the probability of approval by a given recipient under varying contextual and message-related factors. This estimation may be used to trigger conditional workflows (e.g., delayed posting, automated requests for clarification, or deferred public display).

The gratitude system 100 processes and analyzes the first and second permission levels, e.g., using the machine learning model trained on historical sender-recipient interactions, gratitude notification metadata, and prior privacy settings to reconcile any conflicts between the first and second permission levels, and to determine an associated permission level for the gratitude notification. For example, the machine learning model is a supervised learning model trained on labeled training data comprising gratitude notification attributes and reconciled permission outcomes. The machine learning model adjusts its reconciliation outputs based on user override actions or feedback signals indicating user satisfaction with prior publication outcomes. The machine learning model is further configured to analyze and recommend default permission levels for future gratitude notifications based on contextual similarity to previously reconciled notifications.

In an embodiment, the machine learning model incorporates contextual data including time of day, device type, or geographic location to further refine reconciliation of permission levels. The machine learning model infers the sender's and/or recipient's permission level in the absence of explicit input, based on historical behavioral data and social graph analysis. For example, the machine learning module includes a predictive model trained to estimate the likelihood that a recipient will approve public sharing, prior to actual reconciliation. The predictive model is trained with user-specific or group-specific training data to tailor predictions to demographic, cultural, or organizational contexts. The gratitude system 100 includes a user dashboard interface to review and modify the machine learning model's rationale or prediction before publication.

In some embodiments, the gratitude system 100 includes an interpretability interface or dashboard accessible to one or both parties (sender and/or recipient), allowing them to view the rationale behind the system's recommendation. The rationale may include weightings assigned to various factors, including historical behavior, contextual data, or model confidence scores. The interface may allow users to override or adjust the recommendation and to provide structured or freeform feedback, which is recorded and may be fed back into the system for retraining or model adjustment. Additionally, the gratitude system 100 may be configured to support user-specific or organization-specific model profiles. In this mode, the machine learning model may be trained or fine-tuned on local or segmented datasets specific to a group, demographic, or institution. This customization allows the system to reflect cultural norms or group-level privacy expectations.

The gratitude notification is posted by the gratitude system 100 on one or more social media systems 200a-n of the recipient when permissible in accordance with the reconciled permission levels at step 928. The gratitude notification is also displayed on the website for the gratitude system 100. The gratitude notification is also posted by the gratitude system 100 on one or more social media systems 200a-n of the sender when permissible in accordance with the reconciled permission levels at step 930. At 932, the gratitude system 100 obtains and processes feedback, e.g., from recipients or third-party viewers of public gratitude notifications. Feedback may be explicit (e.g., rating buttons or comments) or implicit (e.g., engagement signals such as views, shares, or time spent). This feedback is stored in association with the originating gratitude notification and may be used to retrain the machine learning model over time.

In an embodiment, the gratitude application 118 is implemented as part of another application or platform, such as a third-party communication platforms including email clients (e.g., Google Gmail®, MS Outlook®) or enterprise messaging platforms (e.g., Slack®, MS Teams™), a Customer Relationship Management (CRM) systems (such as Salesforce®), or fundraising platforms. The integration may be facilitated through browser extensions, APIs, or platform software development kits (SDKs). Upon detecting an outbound message or reply in progress, the integrated gratitude application 118 accesses contextual metadata from the message, such as recipient address, domain, prior communication content, and sender history. An NLP-based module generates one or more suggested gratitude notifications that match the inferred relationship role and tone, which are then presented in-line within the communication interface for user selection. The suggested messages includes various selectable tones, contexts, lengths, vigor, and structure presets. The gratitude application 118 logs the selected suggested message and recipient classification to a centralized gratitude analytics database.

FIG. 9C illustrates a method 940 for generating the notification database 212 in the gratitude system 100. At 942, the data for a plurality of gratitude notifications is stored in the notification database 212 including the permission levels associated with each of the plurality of gratitude notifications. For example, the permission level(s) for the sender and recipient of a gratitude notification is stored as well as the reconciled or associated permission level. In some embodiments, the system maintains a version-controlled record of each gratitude notification, including a timestamped log of permission level assignments, overrides, and changes. Each revision of the gratitude notification may be stored with a unique identifier and linked to audit trails for compliance or administrative review.

The gratitude system 100 then allows or restricts access to the data for a gratitude notification in accordance with the associated permission level at 944. A sender and/or receiver may change their permission level, e.g., provided authentication is performed to confirm their identity. The gratitude system 100 will then determine a new reconciled permission level and determine whether the gratitude notification may be publicly accessible in view of the change.

FIG. 9D illustrates a method 950 for accessing and searching the notification database 212 in the gratitude system 100. At 952, a search request including one or more search terms or fields is obtained from a first user device 140a-d. For example, the search terms or fields include one or more of recipient, sender, donation, service, keyword, etc. In response to the search request, the notification database 212 is searched for gratitude notifications that meet the requested search fields at 954 and search results are obtained with one or more gratitude notifications at 956. The associated permission levels for the search results are then processed to determine whether access is permitted to each of the gratitude notifications in the search results at 958. For example, one or more gratitude notifications may be removed if their associated permission levels do not allow access to the first user at 960. A modified search result of the gratitude notifications is then generated and communicated to the first user device 140a-d at 962. The modified search results only provides access to data elements associated with the gratitude notifications that have a permission level that is “public” or other permission level that includes the first user.

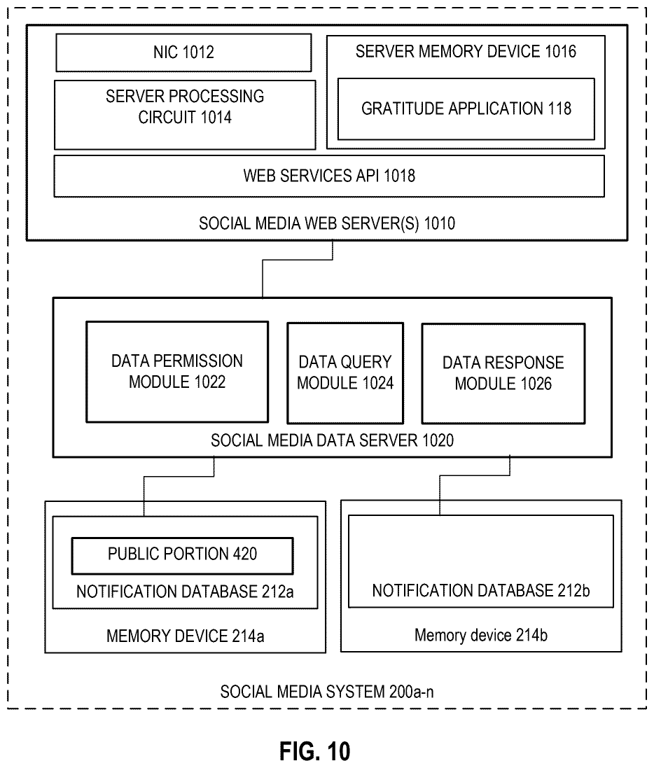

In an embodiment shown in FIG. 10, the gratitude system 100 is incorporated into at one of the social media systems 200a-n. The user devices 140a-n access the social media system 200a-n to perform the functions described herein with respect to the gratitude system 100. The users create user profiles in the social media system 200a-n including associated contact data, such as email, text, phone number, social network accounts, physical address, etc. The user profiles may be associated with an individual user, a company, non-profit, school, retail, political party, government agency, informal group (such as a book club or child's sports team), or other public or private organization. The social media system 200a-n incorporates the gratitude system 100 to provides users 160a-b with the ability to send and receive gratitude or thank you notifications to a recipient and publicly or privately post the notifications to other user accounts in the social media system 200a-n.

In an embodiment, the social media system 200a-n includes one or more social media web servers(s) 1010 including a network interface card (NIC) 1012 or separate load balancer device that provides load balancing and authentication capability to some or all the resources of the social media system 200a-n. The NIC 1012 includes a wireless or wired transceiver with firewall, gateway, and proxy server functions. The social media web server 1010 includes a server processing circuit 1014 and server memory device 1016 that stores the gratitude application 118. The gratitude application 118 is a custom application built using a programming language like Python, Java, or Ruby and incorporated into the social media system 200.

The social media web server 1010 communicates over a private network with the social media data server 1020. The social media data server 1020 manages the social media data, including the notification database 212a-b. In an embodiment, the notification database 212a-b is stored as one or more databases on the one or more memory devices 214a-b in the social media system 200. The memory devices 214a-b may be included as part of the social media data server 1020 or may be separate devices.

This tiered architecture is more secure because the user devices 140a-n do not directly access the data in the social media data server 1020 or memory devices 214a-b. The web services API 1018 provides an interface for communication between the social media web server 1010 and the social media data server 1020. The social media data server 1020 may then access any requested data in the notification database 212a-b and provide the requested data to the social media web server 1010, e.g., for communication to the user devices 140a-d. The social media data server 1020 may include a data permission module 1022 that determines the permission level for a data field and may store public data fields in a separate public portion 420 of the notification database 212a-b. Thus, data fields with a restricted permission level are separated and more secure. A data query module 1024 may receive the data request from the web services API 1018 and generate a search or data filter for searching the notification database 212a-b. The data response module 1026 may receive the search results and generate a response to the web services API 1018.

The servers, memory devices, and databases shown in FIG. 10 are merely exemplary, and servers and/or databases may be omitted, added, or substituted without departing from the scope of the present invention. In addition, different system architectures may be implemented that perform the functions described herein. The social media system 200a-n thus provides a special purpose computing system configured for provision of the new methods and functions described herein. The social media system 200a-n includes significant additional elements with tangible physical form and provides a practical application for performing one or more unique methods described herein that may only practically be performed by a computing system, considering the multitude of data, e.g., of the plurality of users, of the plurality of gratitude notifications, database management, and the generation of computer implemented interfaces with new functionality and communications with remote, third party processing devices.

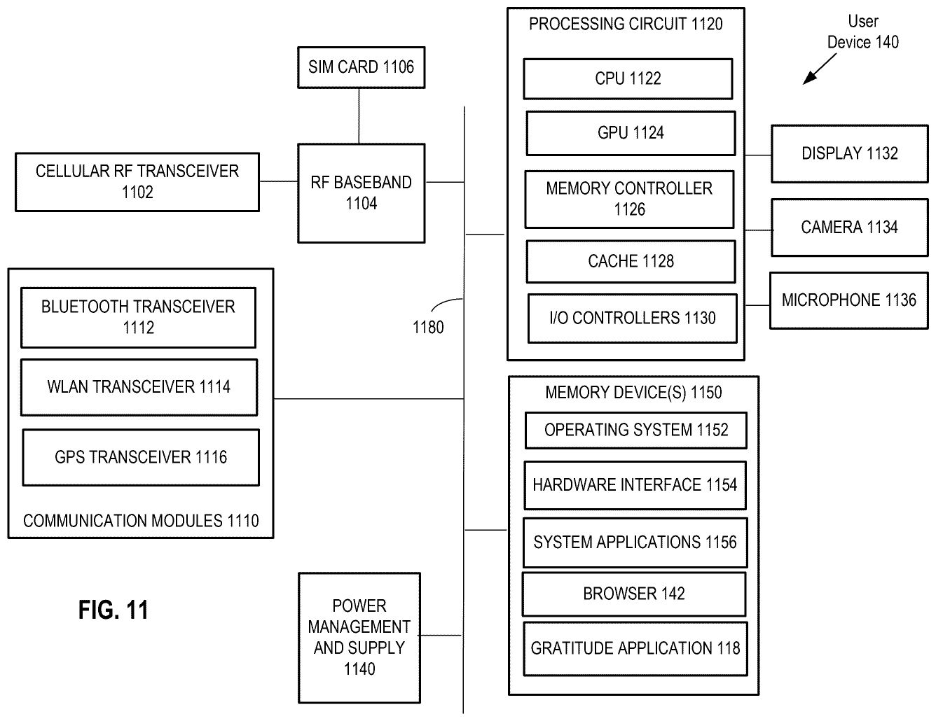

FIG. 11 illustrates a schematic block diagram of an embodiment of at least one of the user devices 140a-n. In this example, the user device 140a-n is a mobile device. The mobile device includes a cellular RF transceiver 1102, RF baseband 1104 and Subscriber Identity Module (SIM) card 1106 to connect to and authenticate with a cellular network for services like calls, texts, and data access. The cellular RF transceiver 1102 may be used to connect to a wide area network, such as the Internet, through the cellular network. The mobile device may include additional communication modules 1110, such as a Bluetooth transceiver 1112, WLAN transceiver 1114, and/or GPS transceiver 1116. The WLAN transceiver 1114 can also be used to connect to a wide area network, such as the Internet, e.g., through an Internet service provider.

The mobile device has one or more processing circuits 1120, such as a System-on-a-Chip (SoC), that integrate a Central Processing Unit (CPU) 1122, Graphical Processing Unit (GPU) 1124, memory controller 1126, memory cache 1128, Input/Output (I/O) controllers 1130 and/or other components. The I/O controllers 1130 interface with one or more peripherals, such as a display 1132, camera 1134, microphone 1136, etc. Power Management and Supply 1140 includes a battery and circuitry for managing power consumption and charging of the mobile device 100.

An operating system (OS) 1152, such as Android® OS developed by Google LLC or iOS® developed by Apple® Inc., is installed on the mobile device to control and operate the components of the mobile device. The operating system 1152 is stored on one or more non-volatile memory devices 1150, such as a read-only-memory (ROM). The operating system 1152, including any runtime components such as Android Runtime (ART) or iOS Runtime, executes applications on the mobile device, such as the gratitude application 118 and/or the browser 142. A hardware interface 1154 or Hardware Abstraction Layer (HAL) provides an interface between the operating system 1152 and the peripherals. System Applications 1156 includes pre-installed applications like text messenger or phone. A bus 1180 communicatively couples the various components of the mobile device.

The user device 140a-n includes a browser 142 and/or gratitude application 118 to perform the functions described herein. The gratitude application 118 may be pre-installed on the mobile device or downloaded and installed, e.g., from an application store/server such as Google Play® or Apple App Store® or from another source. In an embodiment, the gratitude application 118 includes processor-readable instructions, data structures, program modules, application-program interfaces (“APIs”), etc. that when executed by the processing circuit 1120, causes the mobile device 100 to perform one or more functions described herein. For example, the program modules include routines, programs, objects, components, data structures, etc. that perform tasks or implement particular abstract data types. In another embodiment, the mobile device connects to the gratitude system 100 and/or the social media system 200 using the web browser 142 to perform the functions described herein.

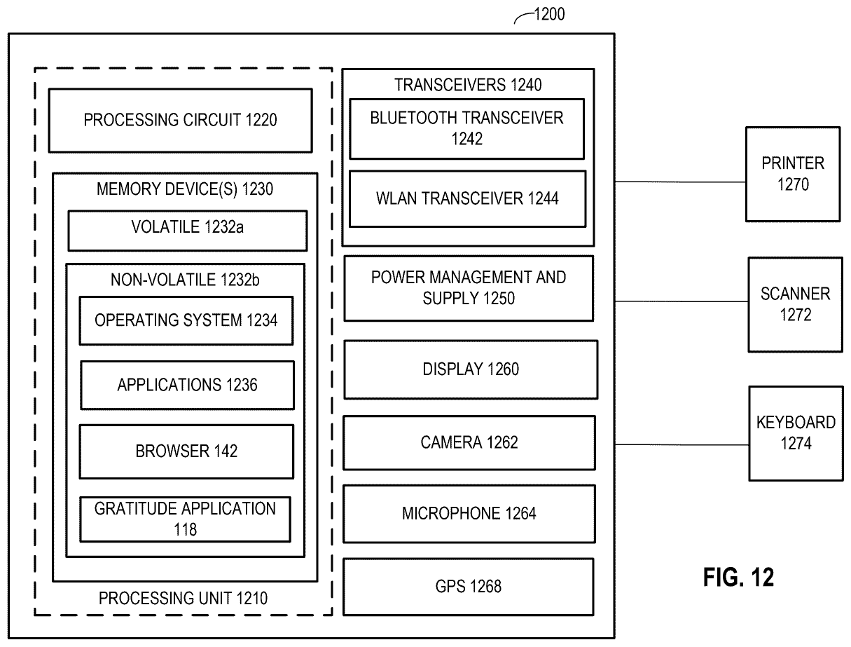

FIG. 12 depicts a schematic block diagram of another exemplary user device 140a-d that, in this example, includes a personal computer or laptop. The user device 140a-d includes a processing unit 1210 having at least one processing circuit 1220 and one or more memory devices(s) 1230. Depending on the exact configuration and type of the user device 140a-d, the memory devices 1230 may include volatile memory 1232a (such as, random access memory (“RAM”)) and non-volatile memory 1232b (such as read-only memory (“ROM”), flash memory, etc.), or some combination of the two. Additional storage may also be included, such as removable storage or non-removable storage, including, but not limited to, magnetic or optical disks or tape, thumb drives, and external hard drives, RAM, ROM, electrically erasable programmable read-only memory (“EEPROM”), flash memory or other memory technology, CD-ROM, digital versatile disks (“DVD”) or other optical storage, magnetic cassettes, magnetic tape, magnetic disk storage or other magnetic storage devices, or any other medium or any other available storage media that can be accessed by the user device 140a-n.

The non-volatile memory 1232b includes an operating system, such Apple®, and/or Windows® operating systems and applications 1236. One of the applications may include the gratitude application 118 and/or browser 142. The gratitude application 118 includes computer-readable instructions, data structures, program modules, application-program interfaces (“APIs”), etc. that when executed by the processing circuit 1220, causes the user device 140a-d to perform one or more functions described herein. For example, the program modules include routines, programs, objects, components, data structures, etc. that perform tasks or implement particular abstract data types. Such programs may be implemented in a high-level procedural or object-oriented programming language to communicate with the computer device. However, the program(s) can be implemented in assembly or machine language, if desired. In any case, the language may be a compiled or interpreted language and combined with hardware implementations. Additionally, and/or alternately, the mobile device connects to the gratitude system 100 and/or the social media system 200 using the web browser 142 to perform the functions described herein.

The user device 140a-d further includes one or more transceivers 1240, such as a Bluetooth transceiver 1242, WLAN transceiver 1244, and/or other wireless or wired transceivers, that allow the computing device to communicate with other devices over one or more networks. Such one or more transceivers include computer-readable instructions, data structures, program modules and/or other data, to transmit a modulated data signal such as a carrier wave or other transport mechanism and includes any information delivery media. By way of example, and not limitation, communication media includes wired media such as a wired network or direct-wired connection, and wireless media such as acoustic, radio frequency (“RF”), infrared and other wireless media. The user device 140a-d may further include a power management and supply 1250 that includes a battery and components for charging and managing the batter power. The user device 140a-d may further include various input/output (I/O) devices, such as a display 1260 or touch screen, touch pad, keyboard, printer, speaker, mouse, etc. The user device 140a-d may also include a camera 1262, microphone 1264 and GPS system 1268. One or more peripheral devices may be coupled to the computing device, e.g., using the Bluetooth transceiver 1242, or a USB port, or other wireless or wired means, such as a printer 1270, scanner 1272 and keyboard 1274.

The gratitude system 100 provides a system and method to generate Thank You notes and/or other gratitude notifications by a sender (individuals, nonprofits, political campaigns, alumni associations, companies, etc.) to thank or show appreciation for a recipient (individuals, nonprofits, political campaigns, alumni associations, companies, etc.). The Thank You note may be transmitted to the recipient using an application on a recipient's device, a website, text, email, instant messenger, Facebook, Instagram, LinkedIn, or other social networks. The gratitude system 100 also includes a privacy system for the sender and receiver to select a permission level of the Thank You note and for one or more individual data elements. When the permission level permits, the Thank You note may be published on a gratitude system website and/or on a social network account of the sender and/or recipient. The gratitude system 100 may also provide an option for the sender to purchase and attach a gift card or send money using the gratitude system 100 or a third-party app (such as PayPal). The gratitude system 100 may provide suggestions to help a sender draft appropriate thank you messages for the occasion, send the thank you to a group of people, schedule when the thank you note is sent to the recipient, or elect to generate and send a more elaborate electronic card. Upon receiving the thank you note, the recipient may opt to display a Thank You confirmation, message, insignia and/or medallion on their social media, which those viewing their social media can click on and obtain additional information on the thank you note. In use, the gratitude system 100 provides a system and method for nonprofits, funding campaigns (such as a GoFundMe®), political party, alumni association, etc., the ability to thank donors publicly and thereby publicize their cause and perhaps obtain more potential donors.

In addition, the gratitude system 100 stores a notification database including Thank you notes or other gratitude notifications and provides a website or portal for searching the database. The publicly shared Thank You notes received by an individual or organization may be searched and listed through the website or portal. This information may be valuable to potential employers, college admissions, or even a potential date. This information may also be valuable to both the sender and the recipient of Thank You notes by preserving a list of those who have helped them.

### Public Response System and Method

A computer-implemented system evaluates public response of an evaluable subject or deeds of an evaluable subject. The system accesses a plurality of third party systems or other data sources and collects structured and unstructured data relating to an evaluable subject and/or a deed performed by the evaluable subject. The system processes the collected data and generates a score reflecting a public response to the evaluable subject and/or deed, such as one or more of a Gratitude Footprint Score, Positive Response Score, or Adverse Response Score. The system generates dashboards, annotated timelines, choropleth maps, or narrative summaries illustrating such scores.

An Evaluable Subject as described herein includes subject matter that receives, is capable of receiving, and/or could potentially receive, a public response. An Evaluable Subject includes, e.g., but is not limited to:
Persons or Actors: individuals, collectives, groups, public figures, celebrities, artificial intelligence systems, fictional characters, artificial intelligence characters, and/or automated agents;
Organizations and Institutions: businesses, companies, nonprofits, educational entities, governments (including governmental bodies and agencies), religious institutions, organized groups, political parties or other legal entity or informal group;
Events and Occurrences: real or fictional events, historical incidents, news items, catastrophes, social movements, product launches, conferences, disasters, anniversaries, elections, protests, ceremonial acts, simulated events, and/or emergent social phenomena
Ideas and Beliefs: ideologies, political ideologies, spiritual doctrines, legal theories, legal cases, legislations (proposed or enacted), laws, regulations, religious principles, memes, societal norms, cultural symbols, scientific paradigms, social movements, belief systems, ethical frameworks, flags, emblems, ritual objects, and/or national icons;
Creative or Cultural Works: including art, films, books, songs, visual media, software, video games, architectural works, NFTs, performances, and intellectual property artifacts, literature, music, architectural works, plays, advertisements, TV shows, web shows, video clips, podcasts, video productions, audio productions, articles, AI generated content, written material, and/or media artifacts;
Products or Services: including consumer products, vehicles, appliances, buildings, tools, clothing, food items, packaging designs, technologies, goods, products, marketing campaigns, commercials, and/or services;
Informational and Digital Constructs: including advertisements, marketing campaigns, social media posts, datasets, platform policies, websites, or app features, product launches, and/or branding initiatives;
Natural and Environmental Subjects: including geographic regions, weather events, climate phenomena, landscapes, ecosystems, species, natural disasters, and geological formations, and/or acts of God;
Physical or Digital creations: including buildings, bridges, vehicles, trains, transportation, infrastructure, digital content, Intellectual property, websites, blogs, podcasts, AI-created content, online content; architectural works, and/or monuments, scientific discovery;
Places and Ecosystems: including towns, villages, cities, states, provinces, counties, continents, landmarks, protected zones, geographical regions, habitats, or natural formations; and
Temporal Constructs: including historical periods, future projections, trends, and ongoing campaigns, cultural eras, holidays, future projections, seasonal trends, milestone anniversaries, commemorative periods, commemorative events, and/or campaign durations.
   The Evaluable Subject may be static, dynamic, abstract, concrete, real, simulated, or proposed.

Deeds include are direct, indirect, observable, stated, or inferred actions, behaviors, communications, creations, events, existence and/or conditions, either by an Evaluable Subject or affecting an Evaluable Subject. Deeds can be explicit or inferred. Explicit deeds include actions or sentiments that are directly stated. Inferred deeds are unstated actions derived from context, linguistic clues, behavioral patterns, indirect actions, or correlated metadata. Inferred Deeds are deduced from contextual evidence, linguistic clues, behavioral patterns, indirect actions, correlated metadata, causality chains, or proximity to attributed events. For example, Inferred Deeds are deduced from one or more of: Linguistic cues (e.g., “Thanks to this initiative . . . ” implies prior action); Attribution gaps (e.g., reporting a result without naming actors); Statistical correlations in behavioral patterns (e.g., recurring patterns of social good following similar interventions); Causal or relational proximity (e.g., praise or backlash directed at a surrounding initiative); or Omission detection (e.g., failure to respond to a crisis compared to peers).

Data Sources include social media, news feeds and articles, market data, financial data, charitable records, public databases, corporate reports, user-submitted or verified content, public media, private communications, donation records, governmental databases, websites, blogs, podcasts, formal reports, informal reports, Academic publications, Literature, legal records, APIs, non-governmental organizations (NGO) or non-profit databases, forums, and publicly available information.

Public Response to a Deed or Evaluable Subject includes an observable, implicit or inferred reaction from observers, stakeholders and/or the public, which may include but is not limited to opinions and expressions of a feeling, such as praise, demand, market sentiment, sentiment, silence, shifts in discourse, symbolic gestures, changes in behavior, or attributed commentary, explicit, implicit and/or inferred expressions of gratitude, perception, praise, love, affection, acknowledgment, criticism, rejection, disapproval, hate, resentment, dislike, social pushback, sentiment, or recognition.

The Public Response Score (also referred to as Score herein) is generated using a configurable scoring engine incorporating sentiment weighting, credibility weighting, time-decay functions, thematic relevance normalization, frequency, cross-source consistency checks, and/or response level-decay functions. Optional grading modules translate numeric scores into visual or symbolic representations for broader interpretability. The Public Response Score may include one or more scores, including but not limited to a Positive Response Score, Adverse Response Score, a Gratitude Footprint and/or any functionally equivalent indicator reflecting Public Response for an Evaluable Subject and/or Deed. The Positive Response Score is a value derived from the volume, credibility, frequency, and sentiment intensity of positive Public Response to Evaluable Subjects and/or Deeds. It may include weighting for recency, impact type, and source trustworthiness. It may also include time-decay, severity calibration, response level-decay and/or response intensity. The Adverse Response Score is a value derived from the volume, credibility, frequency, and sentiment intensity of negative Public Response to Evaluable Subjects and/or Deeds. It may include weighting for recency, impact type, and source trustworthiness. It may also include time-decay, severity calibration, response level-decay and/or response intensity.

The Gratitude Footprint is a composite evaluative profile representing the net public response of an Evaluable Subject. It includes, e.g., a Positive Response Score; Adverse Response Score; Predictive indices (likelihood of future acts); Impact summaries across sectors or geographies; Graded or symbolic representations (e.g., A+, green badge, star rating). The Gratitude Footprint, and/or components thereof, can be weighted for recency, impact type, and source trustworthiness, time-decay, severity calibration, response level-decay and/or response intensity.

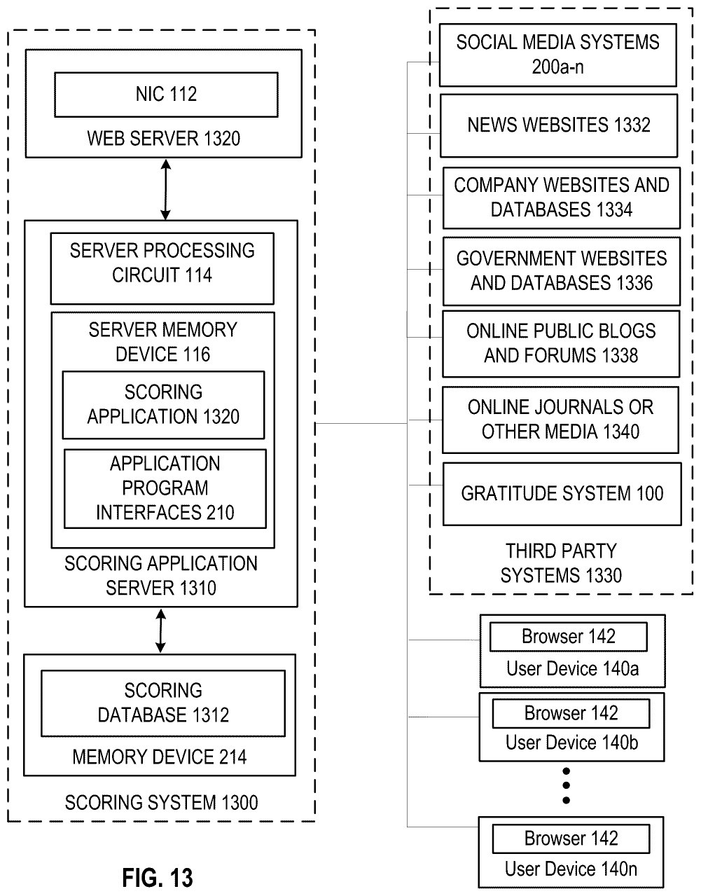

FIG. 13 illustrates a schematic block diagram of a scoring system 1300 in accordance with one or more exemplary embodiments. The scoring system 1300 shown here is exemplary and may include other computer architectures and configurations. The scoring system 1300 is designed with a modular deployment framework enabling operation across one or more platforms, including cloud environments, mobile applications, embedded systems, or high-performance computing environments, and optionally supporting real-time or asynchronous processing, including quantum or neuromorphic computing platforms.

In this example, the scoring system 1300 includes at least one scoring application server 1310 and web server 1320 configured to provide, e.g., a cloud-based application or service, that allows access to the scoring system 1300 by browsers 142 on one or more user devices 140a-n via a wide area network (WAN) or wireless WAN. The browsers 142 include Goggle Chrome®, Microsoft Edge®, Apple Safari®, or another browser. The one or more web browsers 142 interact with the web server 1320 using one or more protocols. For example, the browsers 142 may submit HTTP or other type of protocol request messages to the web server 1320. The web server 1320 provides resources such as HTML files, data or other content and returns a response message to the browser 142. The browser 142 then displays the HTML files, data, or other content to the user devices 140a-n as one or more graphical user interfaces (GUIs).

The web server 1320 includes, e.g., a network interface card (NIC) 112 that includes a wired and/or wireless transceiver for wireless and/or wired network communications with one or more of the user devices 140a-n and the third party systems 1330, e.g., over the exemplary networks 130, 132 in the computing environment 150 as shown in FIG. 1. The NIC 112 may also include authentication capability that requires an authentication process prior to allowing access to some or all the resources of the scoring system 1300. The NIC 112 may also include firewall, gateway, and proxy server functions.

The scoring application server 1310 includes a server processing circuit 114 and a server memory device 116. The server memory device 116 is a non-transitory memory device and may be an internal memory or an external memory. The memory device 116 may be a single memory or a plurality of memories. The memory device 116 may be a read-only memory, random access memory, volatile memory, non-volatile memory, static memory, dynamic memory, flash memory, cache memory, and/or any non-transitory memory device that stores digital information. The server processing circuit 114 includes at least one processor, such as a central processor unit (CPU), microprocessor, microcontroller, embedded processor, digital signal processor, media processor, field programmable gate array, programmable logic device, state machine, logic circuitry, analog circuitry, digital circuitry, and/or any device that manipulates signals (analog and/or digital) based on hard coding of the circuitry and/or operational instructions. The server memory device 116 stores computer-executable instructions which when executed by the server processing circuit 114, causes the scoring system 1300 to perform one or more functions described herein. For example, the server memory device 116 stores a scoring application 1320 including at least a portion of computer-executable instructions executed by the scoring system 1300 to perform the functions described herein. In addition, the scoring system 1300 may maintain a scoring database 1312 in a memory device 214. The memory device 214 (e.g., similar to the memory device 115) may be a separate memory device from the scoring application server 1310 or incorporated into the scoring application server 1310.

The scoring system 1300 includes application program interfaces (APIs) 210 configured to access one or more of the third-party systems 1330. The third-party systems 1330 include, e.g., third party application servers, websites, services, databases, devices, and/or networks. The scoring system 1300 further communicates with the one or more user devices 140a-n, as described with respect to FIG. 1. The users 160 may access the scoring system 1300 using the user devices 140a-n to perform one or more functions described herein.

The depicted computing scoring system 1300 is only one example of a suitable computing environment and is not intended to suggest any limitation as to the scope of use or functionality. Numerous other special purpose computing systems or configurations may be used. Examples of such computing systems, environments, and/or configurations that may be suitable for use include, but are not limited to, personal computers (“PCs”), server computers, handheld or laptop devices, multi-processor systems, microprocessor-based systems, network PCs, minicomputers, mainframe computers, cell phones, tablets, embedded systems, distributed computing environments that include any of the above systems or devices, and the like. The servers, memory devices, processing circuits, NICs, user devices, routers, and other network components shown in FIG. 13 are merely exemplary, and one or more devices may be omitted, added, or substituted without departing from the scope of the present invention.

In an embodiment, the scoring system 1300 collects data from external Data Sources, such as the third-party systems 1330. The third-party systems 1330 include, e.g., one or more social media systems 200a-n, such as LinkedIn®, Facebook®, Instagram®, TikTok®, X™ (aka, Twitter®), Snapchat®, etc. Additional and/or alternate social media systems or applications can also be accessed by the scoring system 1300. The scoring system 1300 also accesses news websites 1332 (such as, CNN.com®; APNEWS.com®, BBC.com®, etc.), company websites and databases 1334 (such as, AMAZON.com®, TEMU.com®, APPLE.com®, YAHOO.com®, YELP.com®, GOOGLE.com®, YOUTUBE.com®, etc.), government websites and databases 1336 (such as, IRS.gov, DATA.gov, USA.gov, etc.), public blogs 1338, public forums 1340 (such as Reddit.com®) as well as the gratitude system 100. The scoring system 1300 collects data from these third party systems 1330 as well as any privately submitted data. For example, the scoring system 1300 includes an optional interaction module enabling verified users to submit evidence, claim profiles, or request score modifications, wherein the submitted data is subject to validation protocols. The collected and submitted data includes, e.g., social media posts, news articles, blogs, forums, donations, verified user submissions, news articles, publicly available data, governmental filings or data, industry or trade group information, corporate data made publicly available, data made available privately, market data, financial data, charitable records, public databases, corporate reports, user-submitted or verified content, public media, private communications, donation records, governmental databases, websites, blogs, podcasts, formal reports, informal reports, academic publications, literature, court records, or other information.

The scoring system 1300 works in a non-Deed Based or Deed Based process. For example, the processing and scoring pathway is configured to operate in:
(a) a three-stage mode comprising: Evaluable Subject→Public Response→Output; and/or
(b) a four-stage mode comprising: Evaluable Subject→Deed→Public Response→Output
   wherein the scoring system 1300 adjusts weighting or analysis pipelines accordingly. In the three-stage mode, a Deed may be treated as the Evaluable Subject itself, or omitted when not explicitly identifiable. In the four stage mode, the scoring system 1300 begins by identifying an Evaluable Subject and then extracts Deeds associated with an Evaluable Subject from Data Sources. Deeds may be explicit (e.g., a charitable donation), implicit, or inferred (e.g., an omission of response during a crisis), and may include passive conditions (e.g., the continued existence of art). Deed extraction employs natural language processing (NLP), rule-based logic, and behavioural inference models. Techniques include semantic parsing, contextual analysis, omission detection, and action mapping. Contextual analysis considers the historical, social, cultural, and other relevant circumstances surrounding a text, event, or situation to gain a deeper understanding of the meaning or possible inferred actions. Inferred Deeds are derived via indirect references, causality chains, or proximity to attributed events. The rest of the process is the same for the non-Deed Based or Deed Based process.

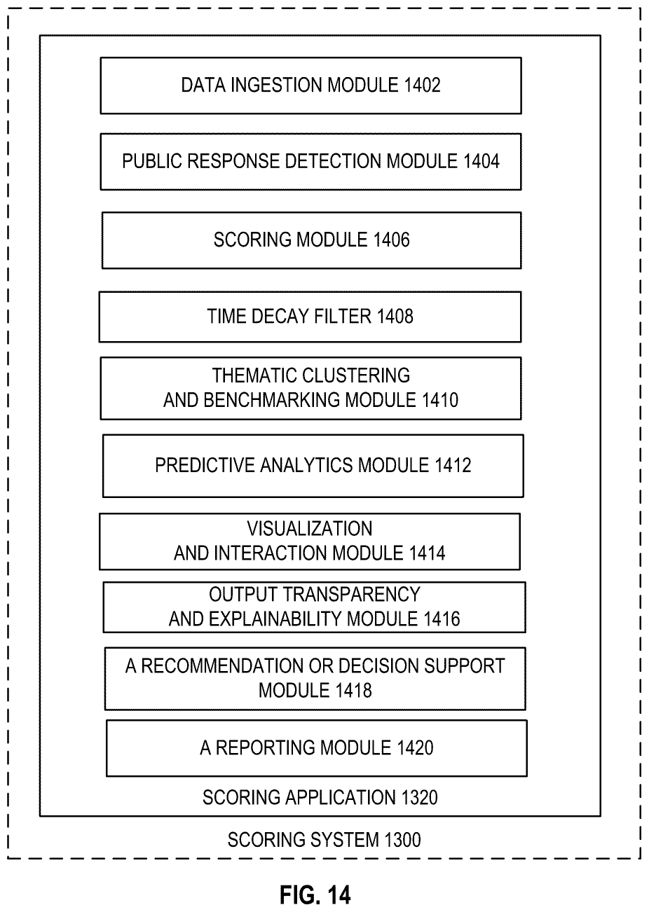

FIG. 14 illustrates a schematic block diagram of the scoring application 1320 operating in the scoring system 1300 in accordance with one or more exemplary embodiments. Though described as operating in the scoring system 1300, the scoring application 1320 has a modular deployment framework enabling operation across different types of platforms, including cloud environments, mobile applications, embedded systems, or high-performance computing environments, and optionally supporting real-time or asynchronous processing, including quantum or neuromorphic computing platforms. The scoring application 1320 includes a plurality of modules or functions implemented in software and/or hardware and operating in the scoring system 1300. The plurality of modules or functions shown herein are exemplary and one or more of the modules can be separated into two or more modules or two or more modules can be combined into one module. Alternate and additional modules can also be implemented with the scoring application 1320.

The Data Ingestion Module 1402 retrieves and collects structured and/or unstructured data from one or more external Data Sources, e.g., the third party systems 1330, or from other publicly accessible sources. The collected data includes textual, behavioural, or metadata elements relevant to Public Responses and associated Deeds or Evaluable Subjects. For example, the collected data includes one or more of: references to the Evaluable Subject, references to Deeds of the Evaluable Subject, and/or references to public response of the Evaluable Subject and/or Deeds of the Evaluable Subject. The Data Ingestion Module 1402 parses and normalizes the collected data. In addition, in one or more embodiments, the scoring application 1320 includes an interaction module enabling verified users to submit data, claim profiles, or request score modifications, wherein the submitted data is subject to validation protocols. Further, in one or more embodiments, the scoring application 1320 includes a verification engine, e.g. using artificial intelligence, configured to assess authenticity and/or credibility of the collected and submitted data using metadata analysis, trust signals, or consistency checks.

A public response detection module 1404 includes a processing engine to detect the public response to the Evaluable Subject and/or Deeds. The processing engine includes one or more of natural language processing, rule-based logic, or other inference methods that are configured to detect, extract, classify, analyze, and associate data related to the Evaluable Subject, Deeds and/or corresponding Public Responses using one or more of: (i) sentiment analysis, (ii) thematic categorization and clustering, (iii) temporal modeling, (iv) credibility weighting, and contextual analysis. The sentiment analysis computationally identifies and categorizes opinions expressed in a piece of text, especially in order to determine whether the attitude towards the Evaluable Subject and/or Deed is positive, negative, or neutral. For example, the Public Responses may be categorized as one of the following: expression of gratitude that includes, e.g., appreciation, thanks, endorsements; a perception or sentiment that includes, e.g. approval, awe, concern, admiration; an acknowledgment or praise that includes, e.g. recognition for social contribution; a criticism or disapproval that includes, e.g., condemnation, disassociation, protest; or a rejection or pushback that includes, e.g., ideological rejection, cancellation, boycott.

Temporal modeling determines the significance of a natural order or sequence of data, and models how past events influence future events, capturing the temporal relationships between data points. The credibility weighting generates weights for data depending on the verifiability or credibility of the source of the data. For example, data that is not from a credible source and/or is not verifiable is given a lower weight than verifiable data from a credible source.

In an embodiment, the public response detection module 1404 uses one or more artificial intelligence (AI) models to detect Public Responses, Deeds and/or an Evaluable Subject. For example, the AI models include one or more of:
a) natural language processing (NLP) models configured to detect, extract, and classify sentiment, intent, and acknowledgment from structured and unstructured text across multiple languages, including detection of implicit and indirect linguistic cues;
b) machine learning classifiers trained on labelled datasets comprising examples of Deeds and Public Responses, the datasets incorporating contextual metadata, source credibility indicators, and domain-specific features;
c) neural network architectures selected from the group consisting of: i) convolutional neural networks (CNNs) for semantic pattern recognition and hierarchical feature extraction; ii) recurrent neural networks (RNNs), including long short-term memory (LSTM) networks, for modeling temporal dependencies in sequential data; and iii) transformer-based models (e.g., BERT, ROBERTa, GPT) for context-aware analysis of long-form and disambiguated language in high-dimensional embeddings; and
d) calibration and interpretability submodules configured to: i) assign machine-generated confidence scores to Public Responses; and ii) output audit-traceable metadata including rationale attribution, feature influence scores, and explanatory tokens;
e) ensemble learning frameworks comprising combinations of heterogeneous models to increase robustness against domain shifts, reduce overfitting to specific linguistic forms, and harmonize outputs across multiple data sources or platform-specific variants.

The scoring module 1406 generates a Public Response Score, or a functionally equivalent public response evaluation metric. The scoring module 1406 applies configurable scoring parameters including user-defined, domain-specific, or system-default weights. The scoring module 1406, in an embodiment, supports dynamic weighting, credibility adjustment, and normalization of the Public Response Score. The scoring module 1406, in an embodiment, uses a temporal decay filter 1408 to weight Deeds and/or Personal Responses, based on configurable settings and weights.

The thematic clustering and benchmarking module 1410 enables comparative analysis and thematic clustering. The thematic clustering portion of the module 1410 groups related Evaluable Subjects, Deeds and/or Public Responses based on one or more shared semantic, contextual, or domain-level features, e.g., to identify macro-patterns and micro-patterns. For example, the module 1410 groups clusters of data by structural, financial (e.g. market capitalization, net revenue, gross revenue), industry (e.g. technology, pharmaceutical, construction, banking), domain (e.g., education, health, environment), sector, revenue tier, market capitalization range, geographic region (e.g. city, state, country), organization type (e.g. not-profit, government, corporation), demographic, Deed type, thematic categories, sentimental classification, or temporal window, entity-specific characteristics, topic, ideological affiliation, and/or impact magnitude. The module 1410 uses topic modeling; unsupervised clustering (e.g., k-means, DBSCAN); transformer-based embedding clustering; domain- or sector-specific labelling logic. The benchmarking portion of the module 1410 performs comparative scoring within a defined thematic clusters or groups, such as sector, industry, market capitalization, or geography. The module 1410 also uses normalization for fair comparisons across evaluable subjects of differing scale, size, total revenue, contribution to GNP, etc., within a defined thematic cluster or group.

The predictive analytics module 1412 includes a predictive module capable of forecasting future behavior and public response. This module 1412 leverages multiple input dimensions, including: temporal trends in historical Deeds and associated public response patterns; Public Response trajectory modeling and event sequencing; symbolic role evolution, including influence graphs and behavioral archetype shifts; and causal inference techniques and domain-specific correlation models. The predictive engine may utilize machine learning algorithms such as recurrent neural networks (RNNs), transformer-based sequence models, or ensemble classifiers, optionally augmented with rules-based forecasting heuristics. Confidence scoring is applied to each projection. Forecasted outputs may include projected Positive Response Score, Adverse Response Score, and Gratitude Footprint values, also an optional Public Response Index, as well as confidence intervals and anomaly risk indicators. A scenario simulation functionality models hypothetical Deeds and assesses anticipated Public Responses based on similar historical patterns. For instance, a policymaker could evaluate Public Response as a reaction to a proposed regulation using past data on analogous interventions.

A visualization and interaction module 1414 is configured to generate one or more outputs, such as: (i) dashboards, choropleth maps, or relational graphs; (ii) rankings, sentiment trajectories, thematic summaries, or predictive forecasts; and (iii) personalized visualizations filtered or customized by user role, Evaluable Subject type, Deeds, Public Response(s) or thematic clusters. Customizable interfaces support sorting and filtering by domain, geography, sentiment type, or temporal range. The module 1414 authenticates users and allows users to claim profiles, submit documentation, or request score modifications. User submissions are subject to AI-based validation, source credibility scoring, and, if necessary, manual review.

An output transparency and explainability module 1416 provides an explanation of each evaluative output-Positive Response Score, Adverse Response Score, or Gratitude Footprint—with a detailed breakdown of contributing components. Additionally, the module 1416 may generate symbolic or narrative visualizations to enhance transparency—such as badge-level representations, impact timelines, or sector-specific highlight summaries. Optional case studies or improvement suggestions may be auto-generated for subjects with sufficient data volume, enabling targeted feedback or strategies.

In one embodiment, the scoring system 1300 includes a recommendation or decision support module 1418 capable of interpreting output scores and associated evaluative signals to generate contextual alerts, insights, or actionable guidance. These may include suggested public responses, behavioral nudges, campaign adjustments, or content moderation triggers. The system may present such recommendations through user dashboards, exportable reports, or API interfaces to external systems. Threshold triggers, pattern recognition, and anomaly detection may be applied to evaluative outputs to assist decision-making.

In one embodiment, the scoring system 1300 includes a reporting module 1420 that compiles evaluative data into structured reports, dashboards, or visual summaries. These may include temporal plots, symbolic status timelines, contradiction maps, or Score distributions, and may be delivered through APIs, downloadable formats, or live user dashboards.

In one or more embodiments, the scoring system 1300 implements Artificial intelligence (AI) modules to perform key functions including language understanding, behavior inference, public response evaluation, forecasting, and user interaction handling. AI modules may include pretrained language models (e.g., transformers), supervised classifiers, neural networks (e.g., RNNs, CNNs), and ensemble models, as well as unsupervised clustering and anomaly detection frameworks. The AI modules are capable of learning patterns across time, adjusting weightings based on feedback or new data, and adapting scoring thresholds as requirements evolve. AI governance mechanisms may be optionally implemented to mitigate bias, document decision-making rationales, and align system behavior with ethical frameworks. This framework enables multi-stakeholder accountability, real-time impact analysis, and forward-looking reputation management for any Evaluable Subject.

In use, in one example, the scoring system 1300 evaluates the Public Response of a business decisions or internal information that becomes externally visible. The business decision includes, but is not limited to, pricing decisions, executive statements, manufacturing changes, corporate filings, or internal memos that are referenced or reacted to in public forums, social media, or news media. When the business decision enters the public domain and generates public responses, the scoring system 1300 associates those Public Responses with the business decision (e.g., the relevant Evaluable Subject and/or Deed), and incorporates the Public Responses into symbolic role analysis, Gratitude Footprint scoring, and narrative trajectory modeling. The scoring system 1300 analyses disseminated content as well as latent or reactive shifts in symbolic perception that emerge from unintended or uncontrollable information exposure.

The scoring system 1300 does not rely primarily on user-reported data or surveys as in current systems. Rather, the scoring system 1300 detects Deeds and Public Responses using data collected from external reliable sources, such as reputable news feeds, journals, etc. The scoring system 1300 further verifies the collected data, as well as any user submitted data, e.g., using AI-driven verification of content authenticity and credibility. The scoring system 1300 thus generates transparent, traceable scores with verified data from reliable third party sources.

The scoring system 1300 includes advanced techniques such as inferred Deed recognition, wherein the scoring system 1300 detects Deeds even when not explicitly declared, e.g., using AI techniques such as contextual inference, omission detection, behavioral correlation, and causality modeling. The scoring system 1300 uses credibility-weighted sentiment balancing, and predictive analytics that project the likelihood of future behavior. The scoring system 1300 applies layered analytics that include: Sentiment balancing and normalization, inferred Deed detection, Time-decay filters, thematic clustering, contextual analysis, and/or forecasting modules that assess the future probability of Deeds and responses. The scoring system 1300 applies to a broad range of Evaluable Subjects, including not just individuals or organizations, but also events, policies, ideas, products, laws, literature, artworks, infrastructure projects, and social movements.

In an embodiment, one or more of the modules of the scoring system 1300 are implemented using quantum computing frameworks, the quantum implementation including one or more of: a) quantum-enhanced machine learning models selected from the group consisting of quantum support vector machines (QSVMs), quantum neural networks (QNNs), quantum Boltzmann machines (QBMs), and hybrid quantum-classical algorithms, each configured to process high-dimensional behavioral and sentiment data with improved pattern recognition efficiency; b) deployment of said quantum models on quantum processing units (QPUs) or quantum simulators operable via platforms including, but not limited to, Qiskit, PennyLane, Cirq, or equivalent quantum development frameworks; c) application of quantum-based optimization techniques to enhance scoring precision, accelerate the detection of multi-dimensional correlations between Evaluable Subjects, Deeds, and Public Response, and to identify high-complexity clusters or predictive trajectories not feasibly discoverable through classical computation alone.

In an embodiment, one or more of the modules of the scoring system 1300, such as the natural language processing engine, predictive analytics module, or real-time sentiment analyzer, are optionally implemented on neuromorphic computing platforms, the implementation comprising: a) utilization of spiking neural networks (SNNs), event-driven architectures, or biologically inspired neural models configured to emulate the efficiency, parallelism, and temporal dynamics of biological cognition for processing Deeds and Public Responses; b) deployment of said models on neuromorphic hardware platforms, including but not limited to Loihi®, TrueNorth®, or other neuromorphic processors supporting event-based computation and asynchronous signal propagation; c) execution of real-time, low-latency inference for detection and classification of gratitude expressions, Deeds, and sentiment trajectories in edge environments, mobile applications, wearable devices, or embedded systems, thereby enabling energy-efficient and context-aware scoring and feedback.

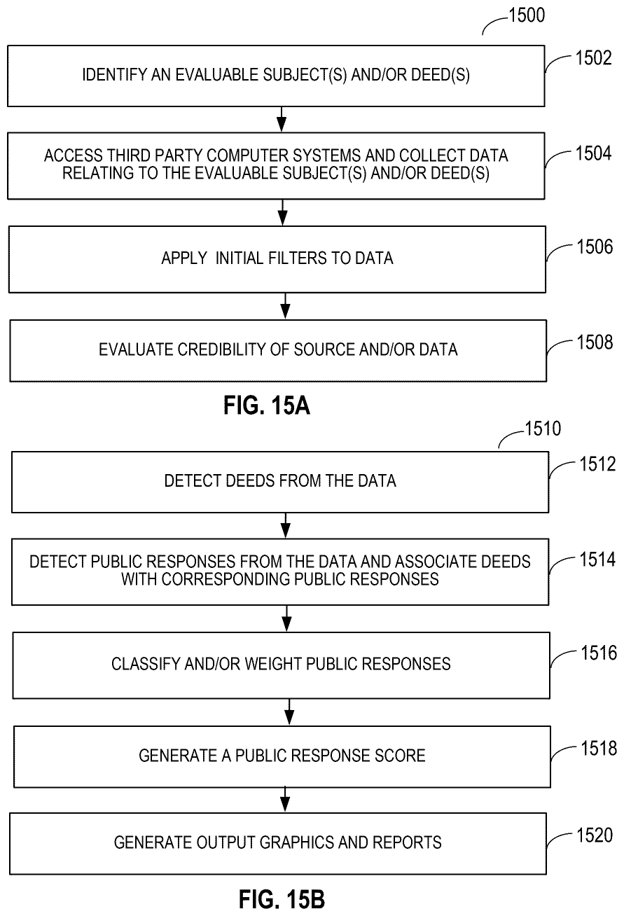

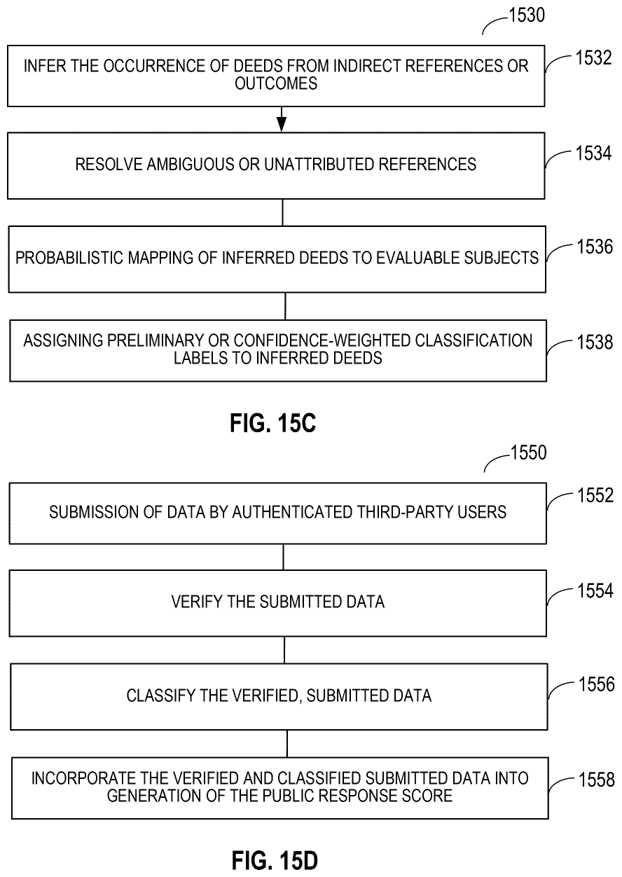

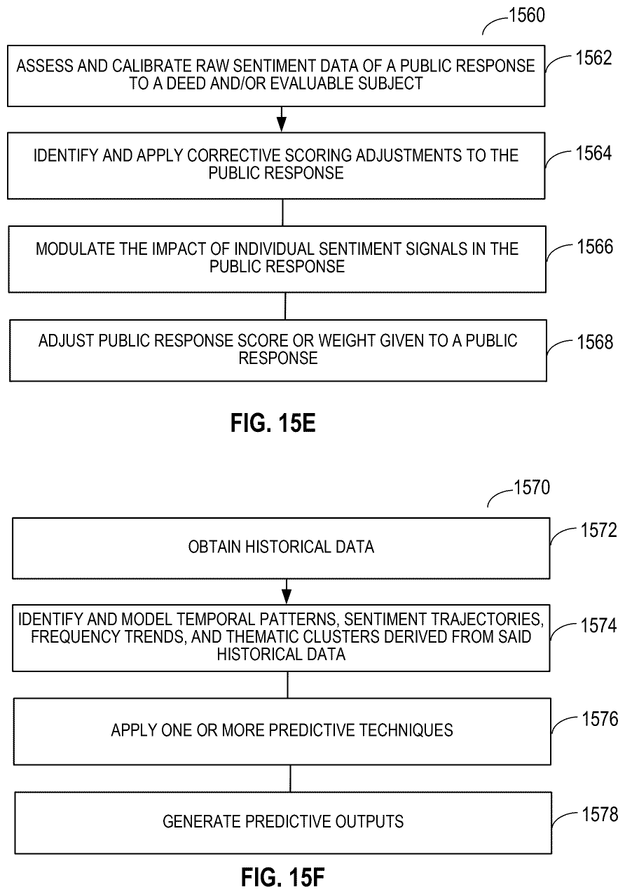

FIG. 15A illustrates a method 1500 for collecting and verifying data in the scoring system 1300. At 1502, an Evaluable Subject and/or Deed is identified, e.g., from user input. The scoring system 1300 obtains the user input defining the Evaluable Subject and Deeds and any defined constraints such as i) category (e.g., education, environment, public health); ii) entity type (e.g., individual, corporation, nonprofit, governmental); iii) geographic region (e.g., country, state, province, region, city, town, village, municipality, or global zone); or iv) sentiment polarity or intensity class.

At 1504, the scoring system 1504 accesses one or more third party computer systems 1330 to collect structured and unstructured data relating to the Evaluable Subject and/or Deed within the defined constraints. The third party systems 1330 include public accessible sources and/or private, user-verified sources, and the data comprises textual, behavioral, or metadata elements relevant to Public Responses, Deeds or Evaluable Subjects.

At 1506, the scoring system 1300 applies initial filters to remove duplicate data, detect manipulation of the data (e.g., through bot-driven amplification) and assess noise levels. For example, the scoring system 1300 detects and filters spam, automated replies, mass duplication, or unverifiable references that may skew the scoring outcomes.

At 1508, the scoring system 1300 evaluates the credibility of the sources of the data, e.g., by checking domain authority, authority history, verification status of the account, etc. The scoring system 1300 applies a credibility score to one or more data sources. For example, a high credibility score of 90% is given to data source, including but not limited to governmental databases, academic journals, peer-reviewed publications, credentialed experts, verified individuals, validated media outlets, or institutional repositories. In addition, a portion of the data, such as a data element or data point, may be verified, e.g., by detecting the same data from 2 or 3 trustworthy sources, and a credibility score is assigned to the portion of data. In an embodiment, the scoring system 1300 is configured to use data and/or data sources with at least a preconfigured credibility score, such as a data source with 90% or greater credibility score or verified data with a 99% credibility score. Alternatively, or additionally, the data is weighted based on its credibility score and/or the credibility score of the source of the data.

FIG. 15B illustrates a method 1510 for scoring Public Responses in the scoring system 1300. At 1512, the scoring system 1300 detects references to Deeds associated with the Evaluable Subject from the collected data, wherein the Deeds include one or more of actions, omissions, conditions, or other behaviors capable of eliciting a Public Response. In an embodiment, Inferred Deeds are detected, as explained in more detail with respect to FIG. 15C. At 1514, the scoring system 1300 detects Public Responses in the collected data and aggregates and associates the Public Responses to corresponding Deeds. The scoring system 1300 uses one or more detection methodologies to detect the Deeds and the Public Responses in the collected data, such as Natural language processing (NLP) and semantic role labelling; temporal sequence modeling; entity resolution and causal inference; sentiment trajectory analysis and anomaly detection; AI modules; probabilistic inference and rules-based logic; and deterministic or heuristic rule-based logic.

At 1516, the scoring system 1300 classifies and weights the extracted Deeds and/or corresponding Public Responses using one or more analytic metrics, including but not limited to: i) sentiment intensity and balance (described in more detail with respect to FIG. 5E); ii) temporal relevance or time-decay weighting; iii) credibility; iv) contextual alignment; and/or v) sarcasm detection, narrative coherence, and stance consistency. For example, with respect to the analytic of credibility, the Deeds and/or Public Responses are assigned a credibility score and/or weighted based on the credibility of the underlying data. The scoring system 1300 assigns elevated weighting factors to Deeds and Public Responses originating from high-credibility sources and data (e.g., sources and data with a high credibility score, e.g., of 90% or higher) and assigns lower weighting factors to Deeds and Public Responses originating from low-credibility sources and data (e.g., sources and data with a low credibility score, e.g., of 89% or lower).

In another example, the scoring system 1300 performs temporal decay analysis or time-relevance adjustment based on a time and/or date of the Public Responses or Deeds. The scoring system 1300 applies a temporal decay function such that the weight applied to Public Responses or Deeds diminishes over time in accordance with one or more decay models, including but not limited to exponential, linear, or context-sensitive decay. Alternatively, the scoring system 1300 dynamically adjusts the weighting of older or newer Public Responses or Deeds based on recency, contextual salience, or user-defined parameters. In another alternative, the scoring system 1300 enables user-configurable decay parameters.

At 1518, the scoring system 1300 generates a Public Response Score of the Evaluable Subjects and/or Deeds based on the aggregated and weighted analysis of the Public Responses, wherein the public response score includes one or more of: a Positive Response Score; an Adverse Response Score; a composite Gratitude Footprint; or any functionally equivalent public response evaluation metric. The scoring system 1300 uses one or more of sentiment polarity; source credibility weighting; temporal decay or time-relevance adjustment; contextual analysis; thematic clustering and domain relevance. For example, using temporal decay or time-relevance adjustment, the scoring system 1300 prioritizes recent Deeds in the calculation of the Public Response Score or optionally enables user-configurable decay parameters based on domain context, thematic clusters, Evaluable Subject categories (e.g., education, health, governance), or stakeholder-defined thresholds.

The scoring system 1300 may include a time-decayed mode, in which historical Deeds and corresponding Public Responses are progressively down-weighted according to a configurable temporal decay function, thereby emphasizing recent activities and contemporary Public Response. In addition, the scoring system 1300 may include a cumulative lifetime impact mode, in which the Deeds and Public Responses are aggregated without temporal discounting, reflecting the Evaluative Subject's Public Responses over time.

In one or more embodiments, the scoring system 1300 uses a dynamic weighting module configured to calibrate the relative scoring influence of Deeds and Public Responses in the computation of a Public Response Score. For example, the scoring system enables configurable weighting parameters, allowing administrators, end-users, or domain-specific experts to assign priority values to particular categories of Deeds (e.g., philanthropic pledges, environmental initiatives) and/or to particular categories of Public Response (e.g., gratitude, perception, acknowledgment, disapproval), based on impact magnitude, sentiment class, or duration of effect. Domain-specific calibration schemas can be implemented, such that distinct scoring rules, thresholds, or normalization coefficients, may be applied per industry sector or per other thematic clustering for Evaluable Subjects. For example, a category-weighting engine applies elevated weights to Deeds associated with certain designated thematic clusters, categories or industries, such as humanitarian aid, environmental sustainability, public health, education, or equity-related initiatives.

In one or more embodiments, the scoring system 1300 incorporates baseline heuristics and normative impact models derived from historical performance patterns, empirical impact benchmarks, and system-defined default logic to ensure continuity of scoring methodology across use cases and/or includes adaptive learning algorithms—such as reinforcement learning or feedback-tuned machine learning models—configured to dynamically update weight distributions in response to evolving data trends, real-world outcomes, user engagement statistics, or validation accuracy feedback. For example, a benchmark-aligned normalization layer, dynamically adjusts score components based on peer group comparisons or domain-specific benchmarks, wherein normalization parameters are derived from Evaluable Subjects, geographic region, industry sector, or historical performance cohorts, to ensure cross-entity comparability and scoring consistency. In an embodiment, authorized system operators or end-users may define custom weighting schemas or select from pre-configured profiles aligned with specific use cases—such as corporate ESG reporting, governmental transparency indices, nonprofit service effectiveness, or philanthropic impact assessment. An adaptive tuning algorithm, e.g., implemented via machine learning or rule-based logic, refines weighting parameters over time based on observed outcome alignment, user feedback loops, validator input accuracy, and longitudinal data trends, thereby improving scoring validity, interpretability, and contextual relevance.

The scoring system 1300 ensures scoring transparency and coherence across system outputs by maintaining logs of the weighting configurations, displaying applied weight values in user-facing interfaces, and enabling audit trails for any modifications or adaptive recalibrations enacted by the scoring system 1300.

At 1520, the scoring system 1300 outputs graphics and reports, including public-facing reports, dashboards, choropleth maps, trend timelines, narrative summaries, or case studies reflecting the Evaluable Subject's public response score, score rationale, and optionally, system-generated recommendations for improving future scores. The scoring system 1300 generates a website or application with Graphical User Interfaces (GUIs) for authenticated or public-facing users to search, filter, and explore one or more of: (i) the Positive Response Score, (ii) the Adverse Response Score, (iii) the Gratitude Footprint, and/or (iv) a functionally equivalent public response evaluation metric, along with associated evaluative data for specified persons, entities, industries, categories, or geographic regions.

The scoring system 1300 can present structured and contextually organized outputs, comprising: (i) identified Deeds, sortable by characteristics including type, domain, sector, revenue tier, market capitalization, geography, organization type, demographic, Deed category, thematic cluster, sentiment classification, temporal window, topic, or impact magnitude; (ii) public responses to such Deeds or directly to the Evaluable Subject; (iii) computed outputs including normalized scores, credibility-weighted metrics, ranking differentials, temporal summaries, predictive forecasts, and benchmark comparisons; support interactive exploration via multimodal visualizations selected from among: dashboards, choropleth or heat maps, sentiment timelines, entity comparison matrices, filterable scorecards, and adjustable search facets by date range, geography, score component, impact category, or evaluable domain. In an embodiment, the output can be in a machine-readable format such as JSON, XML, or CSV for third-party API integration or in a downloadable report or visualization tailored for end-user analysis or public dissemination.

In an embodiment, the scoring system 1300 further includes an auditability and compliance module configured to ensure traceability, regulatory compatibility, and external accountability of the Public Response Score(s), the module comprising: a) a secure, tamper-resistant audit log engine configured to capture and maintain a time-stamped, version-controlled record of: i) scoring calculations, ii) raw and processed data sources, iii) user-submitted or system-inferred updates, iv) rule-based and AI-generated classification outputs, and v) corrections, overrides, or scoring recalibrations; b) a report generation module configured to produce downloadable audit reports detailing: i) data provenance, ii) classification and scoring rationales, iii) modifications over time, iv) credibility assessments, and v) system decisions that materially affect an entity's Score(s); c) a standards-aligned data export interface supporting output in machine-readable formats (e.g., CSV, XML, JSON) conformant with governmental, ESG, nonprofit, or corporate compliance and disclosure frameworks; d) a restricted-access portal for authorized third-party reviewers—such as regulators, auditors, or watchdog organizations-enabling them to: i) search, inspect, and validate scoring outputs, ii) challenge data or classifications with supporting evidence, and iii) request reanalysis or annotations subject to defined system policies and verification protocols.

The audit module may be based on blockchain-based decentralized ledger technologies. For example, a distributed ledger interface is configured to immutably record key system events, including but not limited to: ingestion of Evaluable Subject data, Deed data, Public Response data, Score(s) data, third-party submissions, validation decisions, and revisions to an Evaluable Subject's Score(s). In another example, a cryptographic hashing engine is configured to: i) generate unique hash values for each processed Deed, Public Response, and associated scoring computation, ii) anchor these hashes to the blockchain for tamper-evident validation, and iii) enable time-stamped forensic traceability of each scoring event.

In an embodiment, the scoring system 1300 further includes an ethics and bias mitigation module configured to uphold algorithmic fairness, reduce systemic inequities, and enhance transparency in the computation of Score(s). The ethics and bias mitigation module includes, e.g., a bias detection engine configured to analyse scoring outputs across demographic, geographic, socioeconomic, cultural religious, political affiliation, and sector-based cohorts using fairness-aware machine learning models, counterfactual inference, or statistical disparity detection techniques. The ethics and bias mitigation module further includes, e.g., a dataset and model auditing subsystem configured to: i) evaluate training data distributions for representational imbalances, ii) audit model behavior across protected attributes (e.g., race, gender, age, nationality, culture, religion, class, age, income, location), iii) identify disparate impact or unintended penalization/advantage across population groups, and iv) document mitigation procedures applied. The ethics and bias mitigation module further includes, e.g., a fairness configuration interface allowing system administrators or regulatory integrators to define or select ethical scoring constraints, including but not limited to: i) demographic parity, ii) equalized odds, iii) equal opportunity, iv) minimum fairness thresholds, or v) custom regional, legal, or sector-specific fairness parameters. The ethics and bias mitigation module further includes, e.g., an explainability module configured to: i) generate natural language or visual reports that summarize the factors influencing an individual score, ii) highlight potential sources of bias or disproportionality, iii) provide actionable insights to improve fairness in future classifications, and iv) enable public and private stakeholders to audit algorithmic decisions in a comprehensible format.

FIG. 15C illustrates a method 1530 to detect Inferred Deeds in the scoring system 1300 in more detail. A separate Inferred Deed Recognition module may be included in the scoring application 1320 or incorporated into the public response detection module 1404. The Inferred Deed Recognition module detects and classifies Inferred Deeds that are not explicitly accompanied by public response. At 1532, the occurrence of deeds is inferred from indirect references or outcomes. For example, at 1532, a contextual analysis engine parses linguistic structures, discourse patterns, and narrative cues to infer the occurrence of Deeds from indirect references or outcomes. Additionally and/or alternatively, a behavioral inference model uses one or more of: (i) metadata analysis (e.g., timestamps, source credibility, repetition frequency); (ii) co-occurrence and proximity of social indicators; and (iii) behavioral patterns statistically correlated with known Deed archetypes to infer occurrence of Deeds. At 1534, ambiguous or unattributed references are resolved. For example, a cross-referencing engine resolves ambiguous or unattributed references using entity resolution techniques, enabling probabilistic mapping of inferred Deeds to identifiable Evaluable Subjects. At 1536, the Inferred Deed Recognition module assigns a preliminary or confidence-weighted classification label to an Inferred Deed based on inference strength or validation thresholds. The Inferred Deed is incorporated into the generation of the Public Response Score, with the configurable weighting based on inference strength or validation thresholds.

FIG. 15D illustrates a method 1550 for a data submission in the scoring system 1300 in accordance with one or more embodiments herein. At 1552, data is submitted by an authenticated third-party user/contributor of the scoring system 1300. The authenticated third-party contributor-including individuals, institutions, artificial intelligence systems, collectives, groups, automated agents, governments, or entities-submits structured or narrative content relating to Deeds or Public Responses associated with an Evaluable Subject. At 1554, the Submitted Data, such as, contextual annotations, or evidentiary documentation, is verified, e.g., via rule-based heuristics and/or artificial intelligence models, based on source credibility, evidentiary strength, contextual relevance, perceived impact, and resistance to manipulation. At 1556, the Submitted Data is classified as representing either a Deed or a corresponding Public Response. The verified and classified Submitted Data is dynamically incorporated into the real-time or asynchronous scoring pipeline used to calculate the Public Response Score at 1558.

For example, an authenticated Data Contributor uploads data on a new Deed (or edits or supplements previously recorded Deeds). The Data Contributor associates the new Deed with a specific Evaluable Subject. The Data Contributor may also upload data on a Public Response to the new (or an existing) Deed and tag the new Deed or Public Response with contextual metadata, including geographic location, sentiment classification, credibility indicators, or thematic labels. The Data Contributor can optionally propose preliminary impact assessments or relevance scores for submitted data. In an embodiment, the scoring system 1300 (or an authorized user/Data Validator) reviews, confirms, flags, or contests Deeds and associated Public Responses using verification tools including AI-generated credibility scoring, source triangulation, and manual audit workflows. The scoring system 1300 (or an authorized user/Data Validator) approves, rejects, or requests revision of the user-submitted content.

FIG. 15E illustrates a method 1560 for sentiment analysis and perception balancing of Public Responses in the scoring system 1300 in more detail in accordance with one or more embodiments herein. A separate sentiment and perception balancing module may be included in the scoring application 1320 or incorporated into the public response detection module 1404. The sentiment and perception balancing module is configured to normalize and adjust a Public Response Score by mitigating the effects of disproportionate, manipulated, or biased public sentiment. Raw sentiment data is collected relating to a Deed and/or Evaluable Subject, e.g., using natural language processing. Sentiment data includes any data including an opinion or expression of feeling about the Deed or Evaluable Subject. At 1562, an input normalization engine assess and calibrates the raw sentiment data for a Public Response of a Deed and/or Evaluable Subject based on: i) sentiment intensity and polarity; ii) source credibility and trustworthiness scores; iii) linguistic variance and diversity of origin; and iv) concentration or saturation patterns in source clusters (e.g., echo chambers, regional overrepresentation). The raw sentiment data may be categorized into one of the following: i) expression of gratitude that includes, e.g., appreciation, thanks, endorsements; ii) a perception or sentiment that includes, e.g. approval, awe, concern, admiration; iii) an acknowledgment or praise that includes, e.g. recognition for social contribution; iv) a criticism or disapproval that includes, e.g., condemnation, disassociation, protest; or v) a rejection or pushback that includes, e.g., ideological rejection, cancellation, boycott.

At 1564, the sentiment and perception balancing module identifies and applies corrective scoring adjustments (e.g., to individual Public Responses of a Deed or to the overall Public Response Score) in response to anomalies, including: i) sudden spikes in gratitude or criticism; ii) evidence of coordinated campaigns, sentiment flooding, or artificially amplified narratives; or iii) temporal inconsistencies between event occurrence and sentiment response. At 1566, a contextual weighting engine modulates the impact of individual sentiment data (e.g., data relating to a Personal Response) based on: i) the social reputation or historical credibility of the expressing party or data source; ii) redundancy detection including similar or repetitive submissions of the same individual sentiment data, e.g., by the same data source or by suspected bots; iii) topical alignment between Deeds and the corresponding sentiment data (e.g., gratitude tied to a relevant action vs. unrelated comments); or vi) other context and facts. The overall Public Response score and/or weight applied to a given Public Response is adjusted using one or more of these factors at 1568. In an embodiment, the sentiment and perception balancing module uses an AI-based sentiment debiasing model to perform one or more of these tasks. For example, AI-based sentiment debiasing model is trained using supervised and/or unsupervised learning on known examples of: i) organic versus inauthentic sentiment distributions; ii) bot-generated or AI generated comments, praise or condemnation; iii) influence campaign indicators across known disinformation vectors.

FIG. 15F illustrates a method 1572 of the predictive analytics module 1412 in the scoring system 1300 in accordance with one or more embodiments herein. At 1572, the predictive analytics module obtains historical data, such as Deeds related to an Evaluable Subject and associated Public Responses. At 1574, the predictive analytics module identifies and models temporal patterns, sentiment trajectories, frequency trends, and thematic clusters derived from the historical data. For example, at 1576, the predictive analytics module uses one or more predictive techniques, including: i) machine learning algorithms selected from, but not limited to, recurrent neural networks (RNNs), transformer-based models, ensemble methods, or probabilistic classifiers; and/or ii) rule-based heuristics that extrapolate future outcomes based on historical context and correlation patterns.

At 1578, the predictive analytics module forecasts within a specified temporal horizon: i) the likelihood of a future Deed performed by the Evaluable Subject; and/or ii) the anticipated Public Response of a future Deed performed by the Evaluable Subject. The predictive analytics module can generate one or more of: i) a forecasted Score; ii) a projected score trajectory over time; and/or iii) a probabilistic confidence interval associated with each forecasted output. the predictive analytics module renders the predictive outputs through one or more visual interfaces, including: i) temporal trend graphs; ii) scenario-based simulations; iii) predictive benchmarking dashboards; and/or iv) interactive timelines with impact projection overlays.

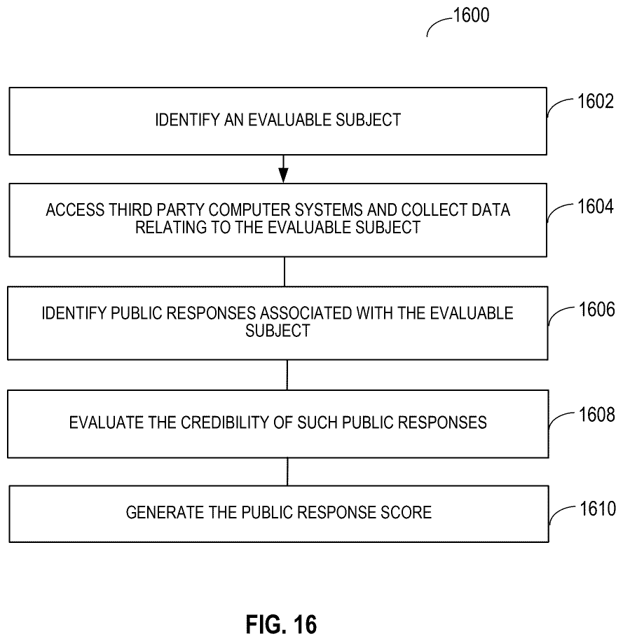

FIG. 16 illustrates a method 1600 of another embodiment of the generating a Public Response Score in the scoring system 1300 in accordance with one or more embodiments herein. The scoring system 1300 may operate in a three-stage mode comprising: Evaluable Subject→Public Response→Output. For example, the three-stage mode is used when an explicit and inferred Deed is not identifiable or present. In another example, the three-stage mode is used when a Deed replaces the Evaluable Subject.

At 1602, an evaluable subject is identified (or replaced by a Deed), e.g., by a user input. At 1604, the scoring system 1300 accesses third party computer systems 1330 and collects data relating to the Evaluable Subject. At 1606, the scoring system 1300 identifies, extracts, and classifies Public Responses associated with the Evaluable Subject. The public responses are attributed directly to the Evaluable Subject without associating them with a distinct Deed, and/or the Evaluable Subject is treated as the Deed for purposes of scoring, in cases where the Deed is implicit, passive, continuous, or inseparable from the identity or existence of the Evaluable Subject. At 1608, the scoring system 1300 evaluates the Public Responses and assigns scores and/or weights to the Public Responses. At 1610, the scoring system 1300 generates a Public Response Score.

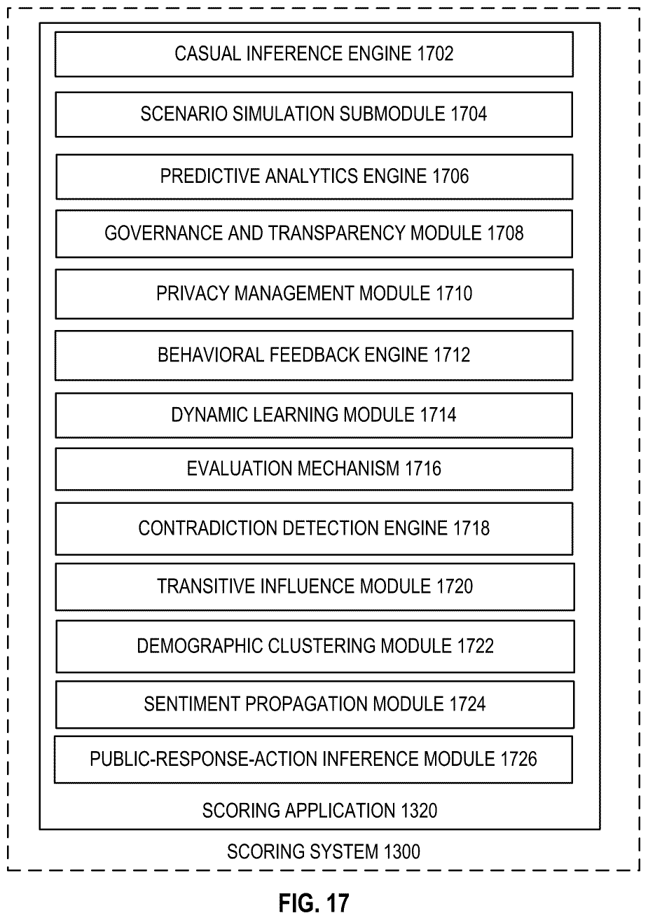

FIG. 17 illustrates a schematic block diagram of another embodiment of the scoring application 1320 operating in the scoring system 1300 in accordance with one or more exemplary embodiments. Though described as operating in the scoring system 1300, the scoring application 1320 has a modular deployment framework enabling operation across different types of platforms, including cloud environments, mobile applications, embedded systems, or high-performance computing environments, and optionally supporting real-time or asynchronous processing, including quantum or neuromorphic computing platforms. The plurality of modules or functions shown in FIG. 17 are implemented in software and/or hardware, e.g., as shown in FIG. 13. The plurality of modules or functions shown herein are exemplary and one or more of the modules can be separated into two or more modules or two or more modules can be combined into one module. The scoring application 1320 includes one or more of the modules shown in FIG. 14 and/or one or more of the modules shown in this FIG. 17. Alternate and additional modules can also be implemented with the scoring application 1320.

In one or more embodiments, the scoring application 1320 includes a causal inference engine 1702 configured to analyse relationships among observed events, Evaluable Subjects, and resulting Public Responses using one or more of: statistical, rule-based, or machine learning models. A scenario simulation submodule 1704 is configured to: i) introduce hypothetical, projected, or third-party variables into the evaluation pipeline; and ii) model expected changes to Deeds, Public Responses, or evaluative metrics based on behavioral patterns, historical analogs, or inter-entity dependencies. A predictive analytics engine 1706 is configured to: i) estimate future score trajectories under specified or simulated conditions; ii) surface potential Deeds or projected Public Responses; and iii) generate alerts, recommendations, or early-warning indicators based on anticipated shifts in sentiment, perception, or volatility. The scoring application 1320 renders scenario outcomes, sensitivity analyses, or comparative forecasts across thematic clusters, geographic regions, or time periods.

A governance and transparency module 1708 is configured to provide oversight, interpretability, and intervention capabilities over the scoring pipeline. The module 1708 includes for example an audit log generator configured to track and store rule-based or model-driven reasoning behind score generation, including feature attribution, model confidence, and data source lineage. The module 1710 includes a user interface configured for authorized users to review, validate, or override Deed classifications or Public Response assignments. The module 1710 further includes a policy engine for enforcing scoring constraints or ethical guardrails, including configurable rules for bias mitigation, reputational protection, or data suppression under legal or regulatory obligations.

The scoring application 1320 further includes a privacy management module 1710 configured to allow Evaluable Subjects to exercise control over the visibility, suppression, or contextualization of their score-related data. The module includes, e.g., a user interface configured for authorized users to control suppression of one or more Scores, Deeds, or Public Responses from public display and mechanisms for requesting temporary redaction or permanent delisting based on predefined criteria including misinformation, defamation, or legal privilege. The module 1710 includes compliance functions for ensuring alignment with jurisdiction-specific privacy frameworks or regional data protection statutes.

The scoring application 1320 further includes a behavioral feedback engine 1712 configured to influence future Deeds of an Evaluable Subject through feedback loops. The engine 1712 includes a notification submodule configured to generate personalized alerts based on recent public response score changes or missed positive reinforcement opportunities. The engine 1712 includes a gamification layer incorporating badges, milestone achievements, or community recognition triggers to encourage beneficial behavior. The engine 1712 includes analytics for measuring the efficacy of nudges on future Deeds, sentiment trends, and longitudinal Score(s) and analysis evolution.

The scoring application 1320 further includes a dynamic learning module 1714 configured to adaptively update classification, analysis, scoring, or modeling components in response to new data. For example, the module 1714 includes a continuous learning pipeline configured to: i) monitor performance degradation, feedback discrepancies, or accuracy drift and ii) trigger retraining or fine-tuning of AI/ML models using newly labeled, ingested, or community-annotated data. The module 1714 includes a weighting engine configured to assign differential importance to training inputs based on one or more of: temporal recency; inference confidence levels; validation or verification status; contextual relevance; and signal strength of Public Responses or Deeds.

The scoring application 1320 further includes an evaluation mechanism 1716 to measure model performances over time, including drift detection, cross-validation scores, and model calibration checks. The module 1716 includes safeguards to ensure version tracking, rollback capabilities, and auditability of model evolution events.

The scoring application 1320 further includes a contradiction detection engine 1718 configured to analyse changes in Public Response or Deeds over time for logical, temporal, or rhetorical inconsistencies. The engine 1718 includes, e.g., a) a polarity shift tracker to identify opposing sentiment on similar Deeds across time or regions; b) a source comparison module to detect conflicting statements from the same Evaluable Subject; c) temporal alignment logic to surface timeline-based contradictions between Deeds and associated Public Responses; d) an inconsistency scoring algorithm to prioritize alerts and flags based on severity, frequency, and source credibility.

The scoring application 1320 further includes a transitive influence module 1720 configured to analyse and visualize the effects of Public Response to an Evaluable Subject on related or peer entities. The module 1720 includes a) a relational mapping engine to detect organizational, hematic, or social linkages among Evaluable Subjects; b) a propagation analysis model to estimate the influence of a Public Response ripple effect across the network; c) a comparison visualization interface rendering inter-subject Score deltas, perceived alignment, or causal correlation; and d) functions for calculating influence scores based on co-occurrence, network centrality, and temporal proximity.

The scoring application 1320 further includes a demographic clustering module 1722 configured to segment, classify, categorize, and analyse Public Responses based on user attributes. The module 1722 includes a) a metadata tagging engine configured to associate each Public Response with demographic markers including but not limited to age range, income, political affiliation, geographic location, religious affiliation, ethnic background, or sociocultural identifiers; b) a segmentation engine configured to group Public Responses into demographic cohorts for the purpose of comparative analysis, scoring, sentiment mapping, or pattern recognition; c) functions for computing intra-group and inter-group sentiment divergence, response intensity, and score variability; and d) visualization components for rendering demographic clusters, trend heatmaps, and sentiment distributions across cohorts.

In an embodiment, the scoring application 1320 is configured to score Public Responses in real time, e.g., during live or unfolding events. For example, the scoring application 1320 includes a) a streaming ingestion layer configured to receive real-time textual, audio, or visual feedback from Data Sources; b) a real-time NLP and classification module configured to detect and classify emergent sentiment, Deeds, and attribution signals with minimal latency; c) a dynamic scoring engine configured to update Score(s) and sentiment metrics continuously as new data is received; and d) alerting functions for surfacing significant inflection points, sentiment reversals, or Deed-triggered response spikes during live observation windows.

In an embodiment, the scoring application 1320 includes a sentiment propagation module 1724 configured to simulate the temporal amplification, decay, or cascading effects of Public Responses over time and across networks. The module 1724 includes: a) a sentiment decay engine configured to apply time-based attenuation functions to previously recorded Public Responses; b) a cascade modeling submodule configured to simulate ripple effects triggered by high-impact Deeds or viral sentiment events, using entity graph propagation or virality coefficients; c) logic for scoring sentiment persistence, amplification thresholds, and temporal sentiment momentum; and d) interfaces for visualizing propagation chains, decay curves, and sentiment saturation across affected Evaluable Subjects or regions.

The scoring application 1320 further includes a Public-Response-action inference module 1726 configured to model, analyze, quantify, and visualize both historical and predicted relationships between Public Response and behavioral actions within one or more thematic clusters of Evaluable Subjects. The module 1726 includes a cluster segmentation engine configured to group Evaluable Subjects into thematic clusters based on shared demographic, psychographic, behavioral, or contextual attributes, including but not limited to geographic location, belief systems, past behaviors, political affiliation, financial attributes, or stated concerns.

The module 1726 also includes a public-response-action correlation and prediction engine configured to detect, classify, analyze, and quantify public response from historical or real-time Public Responses; associate Public Response with actual past Deeds and observable behaviors; infer and predict future actions likely to be undertaken by the public or clusters based on Public Response intensity, language cues, intent declarations, and learned patterns from historical Public Response-action pairs; and calculate conversion ratios representing both historical and projected behavior adoption rates within clusters (e.g., percentage of respondents expected to take action based on Public Response).

The module 1726 further includes a simulation submodule configured to: introduce hypothetical policy changes, events, or conditions; model the resulting Public Response distribution and forecasted behavioral responses, including but not limited to purchasing behavior, voting behavior, protest likelihood, public discourse participation, or other economic actions.

In addition, the module 1726 includes a visualization and benchmarking interface configured to: present comparative Public Response-to-action dynamics across clusters, regions, or time periods; ii) display predictive engagement indices and response likelihoods under specified future scenarios; iii) surface deviations between expected and actual cluster behavior to support model refinement and policy impact assessment.

The module 1726 includes a function to estimate the proportion of individuals within a demographic or thematic cluster likely to take a tangible action beyond expressed sentiment. The module 1726 is configured to a) infer behavioral follow-through based on historical action rates, credibility, and sentiment intensity; b) predict real-world behaviors such as protests, purchases, or votes under future conditions; c) quantify sentiment-to-action ratios across cohorts and time windows; and d) render predictive visualizations of anticipated behavioral shifts.

The scoring system 1300 uses the generated Public Response Score(s) to support downstream decision-making processes by third-parties, such as grantmaking entities, procurement officers, investment firms, or policy advisors. The scoring system 1330 generates decision-support summaries, impact visualizations, or sentiment-adjusted credibility reports. The scoring system 1300 further includes export mechanisms that allow automated integration with CRM, ERP, procurement, or policy drafting platforms.

In an embodiment, a contextualization input interface is configured to receive factual inputs, rebuttals, or clarifying narratives directly from Evaluable Subjects. The module comprises, e.g.,

a) a structured submission tool allowing entity-authenticated context entries tagged by Deed, score, or response; b) a verification mechanism comprising manual review, cross-referencing, and/or crowdsourced validation; c) display logic configured to present accepted contextual information alongside relevant Deeds, Score(s), or Public Responses; d) metadata tagging for version control, timeliness, and source attribution.

In another embodiment, the scoring system 1300 supports a transitive influence module configured to analyze and visualize the effects of Public Response to one Evaluable Subject on related or peer entities. The module includes a) a relational mapping engine to detect organizational, thematic, or social linkages among Evaluable Subjects; b) a propagation analysis model to estimate the influence of a Public Response ripple effect across the network; c) a comparison visualization interface rendering inter-subject Score deltas, perceived alignment, or causal correlation; and d) functions for calculating influence scores based on co-occurrence, network centrality, and temporal proximity.

In another embodiment, one or more modules of the scoring system 1300, such as the scoring and classification modules, are further configured for deployment on resource-constrained or real-time environments, the module comprising: a) model compression techniques such as quantization, pruning, or distillation to reduce computational load; b) low-latency rules-based logic for immediate scoring fallback when AI inference is unavailable; c) neuromorphic or edge AI hardware acceleration support to ensure efficient performance; and d) a prioritization engine to triage and defer non-critical evaluations in bandwidth-limited deployments.

In another embodiment, one or more modules of the scoring system 1300, include a multilingual semantic normalization module configured to interpret, standardize, and preserve cultural meaning across language-diverse Public Responses. The module includes, e.g., a) language detection and translation pipelines configured to convert multilingual input into a common representational format; b) cultural idiom recognition logic configured to map region-specific sentiment indicators, honorifics, and indirect acknowledgment cues to normalized emotional intent; c) cross-cultural semantic alignment algorithms for preserving tone, attribution nuance, and symbolic meaning across diverse linguistic datasets; and d) sentiment calibration logic that adjusts for culturally normalized expressiveness or reticence in public responses, to ensure scoring parity across regions.

In another embodiment, the scoring system 1300 includes a score attribution explainability module configured to provide interpretable explanations for changes in Score(s), analysis or predictions associated with an Evaluable Subject. The module includes, e.g., a) an attribution analysis engine configured to identify and rank the primary contributing factors-including Deeds, Public Responses, contextual metadata, and sentiment shifts—that led to an increase, decrease, or stabilization in a Score or changes in analysis or predictions; b) a temporal influence tracker configured to compare score evolution across defined time intervals, isolating causally-linked events or responses that contributed to each directional change; c) a natural language generation (NLG) submodule configured to produce human-readable justifications for score changes, including confidence levels, data provenance, and weightings; and d) a user interface layer configured to render the explanations in interactive formats, including visual timelines, impact-weighted Deed clusters, and annotated Public Response excerpts.

The benefits, advantages and solutions to problems that have been described herein are merely exemplary. Any benefit, advantage, solution to a problem, or any element that may cause any particular benefit, advantage, or solution to occur or to become more pronounced, are not to be construed as critical, required, or essential features or components of any or all the claims. Additional and/or alternate benefits, advantages and solutions may also become apparent in these embodiments.

It should be noted that the foregoing aspects of the disclosure are merely examples and are not to be construed as limiting the scope of the claims. The description of the embodiments herein is intended to be illustrative, and not to limit the scope of the claims. The various features of the disclosure described herein may be implemented in different systems and devices. The components and/or elements may be assembled or otherwise operationally configured in a variety of permutations. As such, the present teachings can be readily applied to other types of apparatuses, networks, configurations, and methods and many alternatives, modifications, and variations will be apparent to those skilled in the art. Therefore, the embodiments are not limited to the particular examples disclosed herein but also include modifications within the scope of the appended claims.

As used herein, the terms “comprise,” “comprises,” “comprising,” “having,” “including,” “includes” or any variation thereof, are intended to reference a nonexclusive inclusion, such that a process, method, article, composition or apparatus that comprises a list of elements does not include only those elements recited, but may also include other elements not expressly listed or inherent to such process, method, article, composition, or apparatus. Other combinations and/or modifications of the above-described structures, arrangements, applications, proportions, elements, materials, or components used in the practice of the present invention, in addition to those not specifically recited, may be varied or otherwise particularly adapted to specific environments, manufacturing specifications, design parameters, or other operating requirements without departing from the general principles of the same.

As may be used herein, the term “operable to” or “configurable to” indicates that an element includes one or more of circuits, instructions, modules, data, input(s), output(s), etc., to perform one or more of the described or necessary corresponding functions and may further include inferred coupling to one or more other items to perform the described or necessary corresponding functions. As may also be used herein, the term(s) “coupled,” “coupled to,” “connected to,” “connecting,” and/or “communicate with” includes direct connection or link between nodes/devices/networks and/or indirect connection between nodes/devices/network via one or more intervening nodes/devices/networks. As may further be used herein, inferred connections (i.e., where one element is connected to another element by inference) includes direct and indirect connection between two items in the same manner as “connected to” described above. Moreover, nothing disclosed herein is intended to be dedicated to the public regardless of whether such disclosure is explicitly recited in the claims. No claim element is intended to be construed under the provisions of 35 U.S.C. § 112(f) as a “means-plus-function” type element, unless the element is expressly recited using the phrase “means for” or, in the case of a method claim, the element is recited using the phrase “step for.”

Moreover, reference to an element in the singular is not intended to mean “one and only one” but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims.

1. A computer system, comprising:
a transceiver for wireless or wired communication with a plurality of third party systems;
at least one memory device; and
at least one processing circuit, wherein the processing circuit is operatively coupled to the at least one memory device and wherein the at least one memory device stores instructions that, when executed by the at least one processing circuit, causes the computer system to:
access, using the transceiver, data in the plurality of third party systems;
search the data in the plurality of third party systems, using the at least one processing circuit, and collect data relating to an evaluable subject from the plurality of third party systems;
identify in the collected data, using the at least one processing circuit, at least one deed of the evaluable subject, wherein the at least one deed includes at least one of: an action, behavior, communication, creation, event, existence and/or condition, of the evaluable subject;
identify in the collected data, using the at least one processing circuit, one or more public responses associated with the at least one deed;
generate, using the at least one processing circuit, a public response score using the one or more public responses associated with the at least one deed; and
generate, using the at least one processing circuit, a graphical user interface displaying at least the public response score on a display of the computing system.

2. The computer system of claim 1, wherein the plurality of third party systems includes two or more of: a social media system, a news website, a company website, a government website, a public forum, or a journal website.

3. The computer system of claim 1, wherein the computer system is further caused to:
determine a credibility score of the collected data associated with at least a first public response of the one or more public responses;
determine a credibility score for the at least first public response using the credibility score of the associated collected data; and
generate the public response score using the one or more public responses to the at least one deed and the credibility score.

4. The computer system of claim 1, wherein the computer system is further caused to identify in the collected data the at least one deed of the evaluable subject using one or more of:
natural language processing or deterministic or heuristic rule-based logic.

5. The computer system of claim 1, wherein the computer system is further caused to identify in the collected data the one or more public responses to the at least one deed using one or more of: natural language processing, deterministic or heuristic rule-based logic, and sentiment analysis.

6. The computer system of claim 1, wherein the computer system is further caused to generate the public response score using the one or more public responses to the at least one deed by:
generating one or more of: a Positive Response Score; an Adverse Response Score; or a composite Gratitude Footprint.

7. The computer system of claim 1, wherein the computer system is further caused to generate the public response score using the one or more public responses to the at least one deed by:
weighting each of the one or more public responses, wherein the weighting is based on one or more of: sentiment polarity; credibility weighting; contextual analysis; temporal decay or time-relevance adjustment; or thematic clustering.

8. The computer system of claim 1, wherein the computer system is further caused to identify, in the collected data, at least one deed of the evaluable subject by:
identifying an inferred deed that is not explicitly stated in the collected data, wherein the inferred deed is identified by using linguistic structures, discourse patterns, and/or narrative cues to identify the inferred deed from indirect references or outcomes.

9. The computer system of claim 1, wherein the computer system is further caused to:
obtain a data submission from an authenticated user of the computer system;
verify the data submission;
classify the data submission as representing a second deed of the evaluable subject or another public response of the at least one deed; and
update the public response score using the classified data submission.

10. A computer system, comprising:
a transceiver for wireless or wired communication with a plurality of third party systems;
at least one memory device; and
at least one processing circuit, wherein the processing circuit is operatively coupled to the at least one memory device and wherein the at least one memory device stores instructions that, when executed by the at least one processing circuit, causes the computer system to:
access, using the transceiver, data in the plurality of third party systems;
search the data in the plurality of third party systems, using the at least one processing circuit, and collect data relating to an evaluable subject from the plurality of third party systems;
identify in the collected data, using the at least one processing circuit, a plurality of public responses associated with the evaluable subject;
generate, using the at least one processing circuit, a public response score using the plurality of public responses associated with the evaluable subject; and
generate, using the at least one processing circuit, a graphical user interface displaying at least the public response score on a display of the computing system.

11. The computer system of claim 10, wherein the computer system is further caused to:
determine a credibility score for each of the plurality of public responses, wherein the credibility score for each public response is determined based on a credibility of the collected data associated with each public response;
determine a weight to apply to each of the plurality of public responses using the credibility score for each public response; and
generate the public response score using the plurality of public responses and the weight applied to each of the plurality of public responses.

12. The computer system of claim 10, wherein the computer system is further caused to identify the plurality of public responses in the collected data using one or more of: natural language processing, deterministic or heuristic rule-based logic, and sentiment analysis.

13. The computer system of claim 10, wherein the computer system is further caused to:
perform temporal decay analysis or time-relevance adjustment to a weight applied to each of the plurality of public responses; and
generate the public response score using the plurality of public responses and the weight applied to each of the plurality of public responses.

14. A method of a computer system, comprising:
accessing and searching, using at least one processing circuit of the computing system, data stored in a plurality of third party systems;
collecting, from the plurality of third party systems, data relating to an evaluable subject;
identifying in the collected data, using the at least one processing circuit, at least one deed of the evaluable subject, wherein the at least one deed includes at least one of: an action, behavior, communication, creation, event, existence and/or condition, of the evaluable subject;
identifying in the collected data, using the at least one processing circuit, a plurality of public responses associated with the at least one deed;
generating, using the at least one processing circuit, a public response score using the plurality of public responses associated with the at least one deed; and
generating, using the at least one processing circuit, a graphical user interface displaying at least the public response score on a display of the computing system.

15. The method of the computer system of claim 14, wherein the plurality of third party systems includes two or more of: a social media system, a news website, a company website, a government website, a public forum, or a journal website.

16. The method of the computer system of claim 14, further comprising:
determining a credibility score for each of the plurality of public responses; and
generating the public response score using the plurality of public responses to the at least one deed and the credibility score for each of the plurality of public responses.

17. The method of the computer system of claim 14, wherein identifying in the collected data, using the at least one processing circuit, at least one deed of the evaluable subject comprises using one or more of: natural language processing or deterministic or heuristic rule-based logic.

18. The method of the computer system of claim 14, wherein identifying in the collected data, using the at least one processing circuit, a plurality of public responses associated with the at least one deed comprises using one or more of: natural language processing, deterministic or heuristic rule-based logic, and sentiment analysis.

19. The method of the computer system of claim 14, wherein the public response score includes one or more of: a Positive Response Score; an Adverse Response Score; or a composite Gratitude Footprint.

20. The method of the computer system of claim 14, wherein generating, using the at least one processing circuit, the public response score using the plurality of public responses associated with the at least one deed comprises:
weighting each of the plurality of public responses, wherein the weighting is based on one or more of: sentiment polarity; credibility weighting; contextual analysis; temporal decay or time-relevance adjustment; or thematic clustering.

21. The method of the computer system of claim 14, wherein identifying in the collected data, using the at least one processing circuit, at least one deed of the evaluable subject comprises:
identifying an inferred deed that is not explicitly stated in the collected data, wherein the inferred deed is identified by using linguistic structures, discourse patterns, and/or narrative cues to identify the inferred deed from indirect references or outcomes.

22. The method of the computer system of claim 14, further comprising:
obtaining, by the at least one processing circuit, a data submission from an authenticated user of the computer system;
verifying, by the at least one processing circuit, the data submission;
classifying, by the at least one processing circuit, the data submission as representing a second deed of the evaluable subject or another public response of the at least one deed; and
updating, by the at least one processing circuit, the public response score using the classified data submission.

23. The method of the computer system of claim 14, further comprising:
performing, by the at least one processing circuit, temporal decay analysis or time-relevance adjustment to a weight applied to each of the plurality of public responses; and
generating, by the at least one processing circuit, the public response score using the plurality of public responses and the weight applied to each of the plurality of public responses.

24. The computer system of claim 14, wherein the computer system is further caused to:
model a historical relationship between the plurality of Public Responses and the at least one Deed within one or more thematic clusters of the Evaluable Subject; and
predict a future action and/or a future Public Response based on the historical relationship.
